(19) United States
(12) Patent Application Publication
(10) Pub. No.: US 2011/0058676 A1
(43) Pub. Date: Mar. 10, 2011

(54) SYSTEMS, METHODS, APPARATUS, AND COMPUTER-READABLE MEDIA FOR DEREVERBERATION OF MULTICHANNEL SIGNAL

(75) Inventor: Erik Visser, San Diego, CA (US)

(73) Assignee: QUALCOMM INCORPORATED, San Diego, CA (US)

(21) Appl. No.: 12/876,163

(22) Filed: Sep. 5, 2010

Related U.S. Application Data
(60) Provisional application No. 61/240,301, filed on Sep. 7, 2009.

(51) Int. Cl. H04R 5/00

(52) U.S. Cl. 381/17; 381/66

(57) ABSTRACT

Systems, methods, apparatus, and computer-readable media for dereverberation of a multimicrophone signal combine use of a directionally selective processing operation (e.g., beamforming) with an inverse filter trained on a separated reverberation estimate that is obtained using a decorrelation operation (e.g., a blind source separation operation).

### CLAIM OF PRIORITY UNDER 35 U.S.C. §119

The present application for patent claims priority to Provisional Application No. 61/240,301 entitled “SYSTEMS, METHODS, APPARATUS, AND COMPUTER-READABLE MEDIA FOR DEREVERBERATION OF MULTICHANNEL SIGNAL,” filed Sep. 7, 2009, and assigned to the assignee hereof.

### BACKGROUND

1. Field

This disclosure relates to signal processing.

2. Background

Reverberation is created when an acoustic signal originating from a particular direction (e.g., a speech signal emitted by the user of a communications device) is reflected from walls and/or other surfaces. A microphone-recorded signal may contain those multiple reflections (e.g., delayed instances of the audio signal) in addition to the direct-path signal. Reverberated speech generally sounds more muffled, less clear, and/or less intelligible than speech heard in a face-to-face conversation (e.g., due to destructive interference of the signal instances on the various acoustic paths). These effects may be particularly problematic for automatic speech recognition (ASR) applications (e.g., automated business transactions, such as account balance or stock quote checks; automated menu navigation; automated query processing), leading to a reduction in accuracy. Therefore it may be desirable to perform a dereverberation operation on a recorded signal while minimizing changes to the voice color.

### SUMMARY

A method, according to a general configuration, of processing a multichannel signal that includes a directional component includes performing a first directionally selective processing operation on a first signal to produce a residual signal, and performing a second directionally selective processing operation on a second signal to produce an enhanced signal. This method includes calculating a plurality of filter coefficients of an inverse filter, based on information from the produced residual signal, and performing a dereverberation operation on the enhanced signal to produce a dereverberated signal. The dereverberation operation is based on the calculated plurality of filter coefficients. The first signal includes at least two channels of the multichannel signal, and the second signal includes at least two channels of the multichannel signal. In this method, performing the first directionally selective processing operation on the first signal includes reducing energy of the directional component within the first signal relative to a total energy of the first signal, and performing the second directionally selective processing operation on the second signal includes increasing energy of the directional component within the second signal relative to a total energy of the second signal. Systems and apparatus configured to perform such a method, and computer-readable media having machine-executable instructions for performing such a method, are also disclosed.

An apparatus, according to a general configuration, for processing a multichannel signal that includes a directional component has a first filter configured to perform a first directionally selective processing operation on a first signal to produce a residual signal, and a second filter configured to perform a second directionally selective processing operation on a second signal to produce an enhanced signal. This apparatus has a calculator configured to calculate a plurality of filter coefficients of an inverse filter, based on information from the produced residual signal, and a third filter, based on the calculated plurality of filter coefficients, that is configured to filter the enhanced signal to produce a dereverberated signal. The first signal includes at least two channels of the multichannel signal, and the second signal includes at least two channels of the multichannel signal. In this apparatus, the first directionally selective processing operation includes reducing energy of the directional component within the first signal relative to a total energy of the first signal, and the second directionally selective processing operation includes increasing energy of the directional component within the second signal relative to a total energy of the second signal.

An apparatus, according to another general configuration, for processing a multichannel signal that includes a directional component has means for performing a first directionally selective processing operation on a first signal to produce a residual signal, and means for performing a second directionally selective processing operation on a second signal to produce an enhanced signal. This apparatus includes means for calculating a plurality of filter coefficients of an inverse filter, based on information from the produced residual signal, and means for performing a dereverberation operation on the enhanced signal to produce a dereverberated signal. In this apparatus, the dereverberation operation is based on the calculated plurality of filter coefficients. The first signal includes at least two channels of the multichannel signal, and the second signal includes at least two channels of the multichannel signal. In this apparatus, the means for performing the first directionally selective processing operation on the first signal is configured to reduce energy of the directional component within the first signal relative to a total energy of the first signal, and the means for performing the second directionally selective processing operation on the second signal is configured to increase energy of the directional component within the second signal relative to a total energy of the second signal.

### BRIEF DESCRIPTION OF THE DRAWINGS

FIGS. 1A and 1B show examples of beamformer response plots.

FIG. 2A shows a flowchart of a method M100 according to a general configuration.

FIG. 2B shows a flowchart of an apparatus A100 according to a general configuration.

FIGS. 3A and 3B show examples of generated null beams.

FIG. 4A shows a flowchart of an implementation M102 of method M100.

FIG. 4B shows a block diagram of an implementation A104 of apparatus A100.

FIG. 5A shows a block diagram of an implementation A106 of apparatus A100.

FIG. 5B shows a block diagram of an implementation A108 of apparatus A100.

FIG. 6A shows a flowchart of an apparatus MF100 according to a general configuration.

FIG. 6B shows a flowchart of a method according to another configuration.

FIG. 7A shows a block diagram of a device D10 according to a general configuration.

FIG. 7B shows a block diagram of an implementation D20 of device D10.

FIGS. 8A to 8D show various views of a multi-microphone wireless headset D100.

FIGS. 9A to 9D show various views of a multi-microphone wireless headset D200.

FIG. 10A shows a cross-sectional view (along a central axis) of a multi-microphone communications handset D300.

FIG. 10B shows a cross-sectional view of an implementation D310 of device D300.

FIG. 11A shows a diagram of a multi-microphone media player D400.

FIGS. 11B and 11C show diagrams of implementations D410 and D420, respectively, of device D400.

FIG. 12A shows a diagram of a multi-microphone hands-free car kit D500.

FIG. 12B shows a diagram of a multi-microphone writing device D600.

FIGS. 13A and 13B show front and top views, respectively, of a device D700.

FIGS. 13C and 13D show front and top views, respectively, of a device D710.

FIGS. 14A and 14B show front and side views, respectively, of an implementation D320 of handset D300.

FIGS. 14C and 14D show front and side views, respectively, of an implementation D330 of handset D300.

FIG. 15 shows a display view of an audio sensing device D800.

FIGS. 16A-D show configurations of different conferencing implementations of device D10.

FIG. 17A shows a block diagram of an implementation R200 of array R100.

FIG. 17B shows a block diagram of an implementation R210 of array 8200.

### DETAILED DESCRIPTION

This disclosure includes descriptions of systems, methods, apparatus, and computer-readable media for dereverberation of a multimicrophone signal, using beamforming combined with inverse filters trained on separated reverberation estimates obtained using blind source separation (BSS).

Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, estimating, and/or selecting from a plurality of values. Unless expressly limited by its context, the term “obtaining” is used to indicate any of its ordinary meanings, such as calculating, deriving, receiving (e.g., from an external device), and/or retrieving (e.g., from an array of storage elements). Where the term “comprising” is used in the present description and claims, it does not exclude other elements or operations. The term “based on” (as in “A is based on B”) is used to indicate any of its ordinary meanings, including the cases (i) “derived from” (e.g., “B is a precursor of A”), (ii) “based on at least” (e.g., “A is based on at least B”) and, if appropriate in the particular context, (iii) “equal to” (e.g., “A is equal to B”). Similarly, the term “in response to” is used to indicate any of its ordinary meanings, including “in response to at least.”

References to a “location” of a microphone of a multi-microphone audio sensing device indicate the location of the center of an acoustically sensitive face of the microphone, unless otherwise indicated by the context. The term “channel” is used at times to indicate a signal path and at other times to indicate a signal carried by such a path, according to the particular context. Unless otherwise indicated, the term “series” is used to indicate a sequence of two or more items. The term “frequency component” is used to indicate one among a set of frequencies or frequency bands of a signal, such as a sample of a frequency domain representation of the signal (e.g., as produced by a fast Fourier transform) or a subband of the signal (e.g., a Bark scale subband).

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. The terms “apparatus” and “device” are also used generically and interchangeably unless otherwise indicated by the particular context. The terms “element” and “module” are typically used to indicate a portion of a greater configuration. Unless expressly limited by its context, the term “system” is used herein to indicate any of its ordinary meanings, including “a group of elements that interact to serve a common purpose.” Any incorporation by reference of a portion of a document shall also be understood to incorporate definitions of terms or variables that are referenced within the portion, where such definitions appear elsewhere in the document, as well as any figures referenced in the incorporated portion.

Dereverberation of a multimicrophone signal may be performed using a directionally discriminative (or “directionally selective”) filtering technique, such as beamforming. Such a technique may be used to isolate sound components arriving from a particular direction, with more or less precise spatial resolution, from sound components arriving from other directions (including reflected instances of the desired sound component). While this separation generally works well for middle to high frequencies, results at low frequencies are generally disappointing.

One reason for this failure at low frequencies is that the microphone spacing available on typical audio-sensing consumer device form factors (e.g., wireless headsets, telephone handsets, mobile telephones, personal digital assistants (PDAs)) is generally too small to ensure good separation between low-frequency components arriving from different directions. Reliable directional discrimination typically requires an array aperture that is comparable to the wavelength. For a low-frequency component at 200 Hz, the wavelength is about 170 centimeters. For a typical audio-sensing consumer device, however, the spacing between microphones may have a practical upper limit on the order of about ten centimeters. Additionally, the desirability of limiting white noise gain may constrain the designer to broaden the beam in the low frequencies. A limit on white noise gain is typically imposed to reduce or avoid the amplification of noise that is uncorrelated between the microphone channels, such as sensor noise and wind noise.

In order to avoid spatial aliasing, the distance between microphones should not exceed half of the minimum wavelength. An eight-kilohertz sampling rate, for example, gives a bandwidth from zero to four kilohertz. The wavelength at four kilohertz is about 8.5 centimeters, so in this case, the spacing between adjacent microphones should not exceed about four centimeters. The microphone channels may be lowpass filtered in order to remove frequencies that might give rise to spatial aliasing. While spatial aliasing may reduce the effectiveness of spatially selective filtering at high frequencies, however, reverberation energy is usually concentrated in the low frequencies (e.g., due to typical room geometries). A directionally selective filtering operation may perform adequate removal of reverberation at middle and high frequencies, but its dereverberation performance at low frequencies may be insufficient to produce a desired perceptual gain.

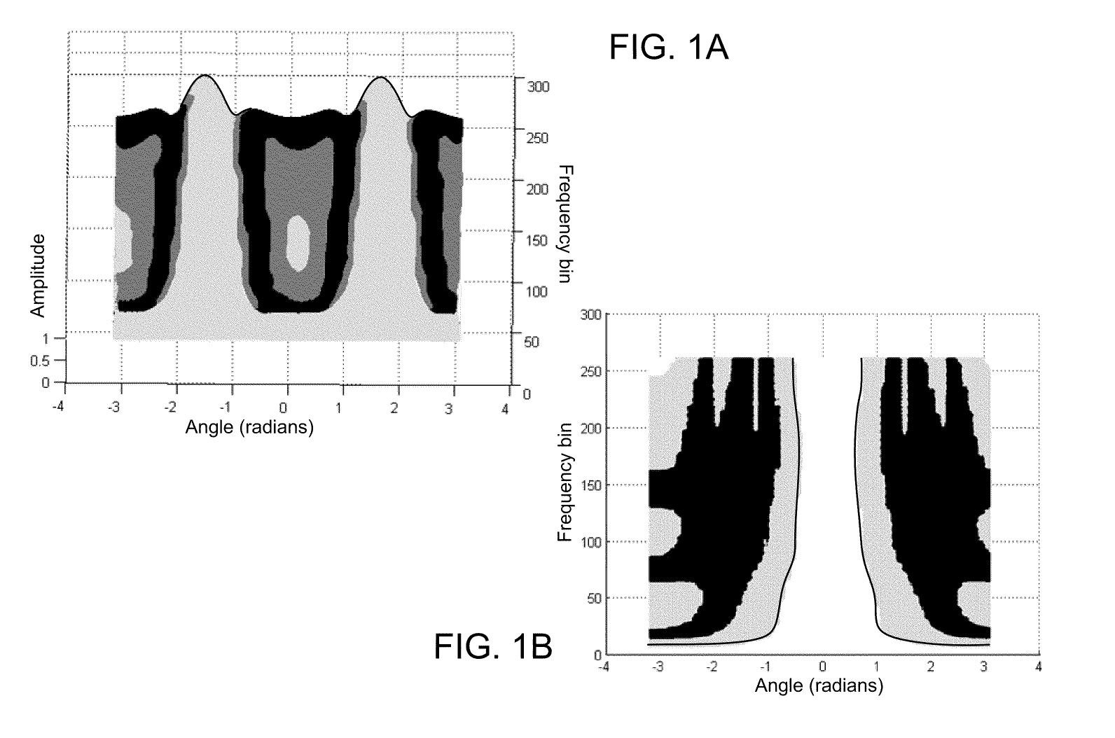

FIGS. 1A and 1B show beamformer response plots obtained on a multimicrophone signal recorded using a four-microphone linear array with a spacing of 3.5 cm between adjacent microphones. FIG. 1A shows the response for a steer direction of ninety degrees relative to the array axis, and FIG. 1B shows the response for a steer direction of zero degrees relative to the array axis. In both figures, the frequency range is from zero to four kilohertz, and gain from low to high is indicated by brightness from dark to light. To increase comprehension, a boundary line is added at the highest frequency in FIG. 1A and an outline of the main lobe is added to FIG. 1B. In each figure, it may be seen that the beam pattern provides high directivity in the middle and high frequencies but is spread out in the low frequencies. Consequently, application of such beams to provide dereverberation may be effective in middle and high frequencies but less effective in a low-frequency band, where the reverberation energy tends to be concentrated.

Alternatively, dereverberation of a multimicrophone signal may be performed by direct inverse filtering of reverberant measurements. Such an approach may use a model such as C(z⁻¹)Y(t)=S(t), where Y(t) denotes the observed speech signal, S(t) denotes the direct-path speech signal, and C(z⁻¹) denotes the inverse room-response filter.

A typical direct inverse filtering approach may estimate the direct-path speech signal S(t) and the inverse room-response filter C(z⁻¹) at the same time, using appropriate assumptions about the distribution functions of each quantity (e.g., probability distribution functions of the speech and of the reconstruction error) to converge to a meaningful solution. Simultaneous estimation of these two unrelated quantities may be problematic, however. For example, such an approach is likely to be iterative and may lead to extensive computations and slow convergence for a result that is typically not very accurate. Applying inverse filtering directly to the recorded signal in this manner is also prone to whitening the speech formant structure while inverting the room impulse response function, resulting in speech that sounds unnatural. To avoid these whitening artifacts, a direct inverse filtering approach may be excessively dependent on parameter tuning.

Systems, methods, apparatus, and computer-readable media for multi-microphone dereverberation are disclosed herein that perform inverse filtering based on a reverberation signal which is estimated using a blind source separation (BSS) or other decorrelation technique. Such an approach may include estimating the reverberation by using a BSS or other decorrelation technique to compute a null beam directed toward the source, and using information from the resulting residual signal (e.g., a low-frequency reverberation residual signal) to estimate the inverse room-response filter.

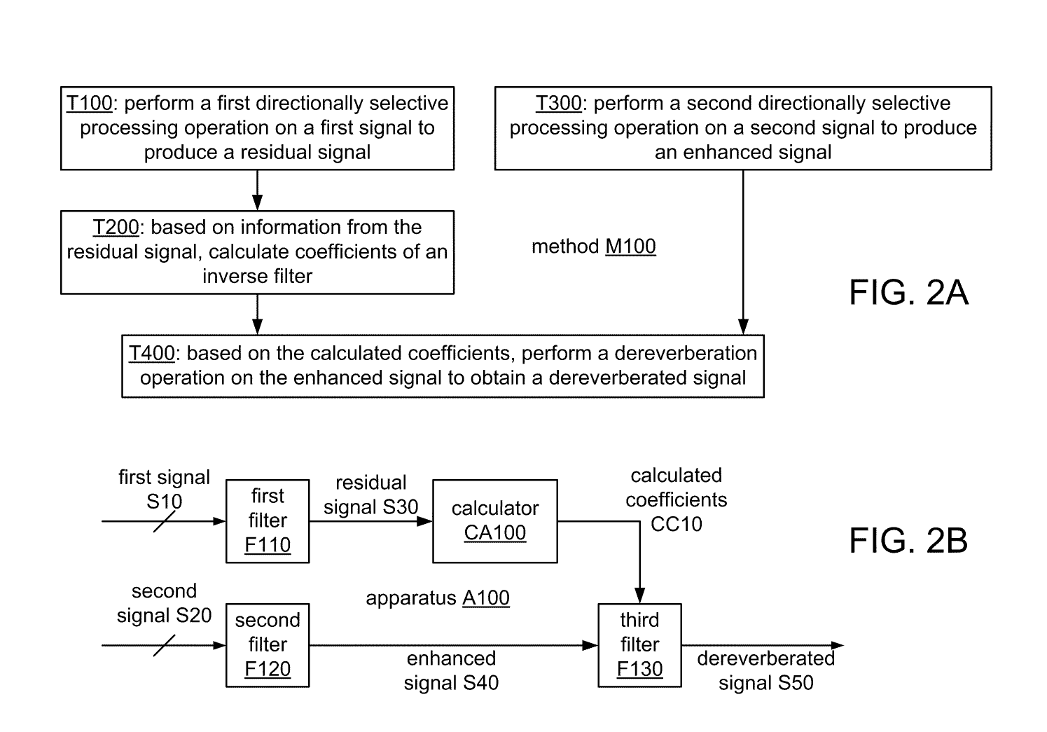

FIG. 2A shows a flowchart of a method M100, according to a general configuration, of processing a multichannel signal that includes a directional component (e.g., the direct-path instance of a desired signal, such as a speech signal emitted by a user's mouth). Method M100 includes tasks T100, T200, T300, and T400. Task T100 performs a first directionally selective processing (DSP) operation on a first signal to produce a residual signal. The first signal includes at least two channels of the multichannel signal, and the first DSP operation produces the residual signal by reducing the energy of the directional component within the first signal relative to the total energy of the first signal. The first DSP operation may be configured to reduce the relative energy of the directional component, for example, by applying a negative gain to the directional component and/or by applying a positive gain to one or more other components of the signal.

In general, the first DSP operation may be implemented as any decorrelation operation that is configured to reduce the energy of a directional component relative to the total energy of the signal. Examples include a beamforming operation (configured as a null beamforming operation), a blind source separation operation configured to separate out the directional component, and a phase-based operation configured to attenuate frequency components of the directional component. Such an operation may be configured to execute in the time domain or in a transform domain (e.g., the FFT or DCT domain or another frequency domain).

In one example, the first DSP operation includes a null beamforming operation. In this case, the residual is obtained by computing a null beam in the direction of arrival of the directional component (e.g., the direction of the user's mouth relative to the microphone array producing the first signal). The null beamforming operation may be fixed and/or adaptive. Examples of fixed beamforming operations that may be used to perform such a null beamforming operation include delay-and-sum beamforming, which includes time-domain delay-and-sum beamforming and subband (e.g., frequency-domain) phase-shift-and-sum beamforming, and superdirective beamforming Examples of adaptive beamforming operations that may be used to perform such a null beamforming operation include minimum variance distortionless response (MVDR) beamforming, linearly constrained minimum variance (LCMV) beamforming, and generalized sidelobe canceller (GSC) beamforming

In another example, the first DSP operation includes applying a gain to a frequency component of the first signal that is based on a difference between the phase of the frequency component in different channels of the first signal. Such a phase-difference-based operation may include calculating, for each of a plurality of different frequency components of the first signal, the difference between the corresponding phases of the frequency component in different channels of the first signal, and applying different gains to the frequency components based on the calculated phase differences. Examples of direction indicators that may be derived from such a phase difference include direction of arrival and time difference of arrival.

A phase-difference-based operation may be configured to calculate a coherency measure according to the number of frequency components whose phase differences satisfy a particular criterion (e.g., the corresponding direction of arrival falls within a specified range, or the corresponding time difference of arrival falls within a specified range, or the ratio of phase difference to frequency falls within a specified range). For a perfectly coherent signal, the ratio of phase difference to frequency is a constant. Such a coherency measure may be used to indicate intervals during which the directional component is active (e.g., as a voice activity detector). It may be desirable to configure such an operation to calculate the coherency measure based on phase differences only of frequency components that are of a specified frequency range (e.g., a range that may be expected to include most of the energy of the speaker's voice, such as from about 500, 600, 700, or 800 Hz to about 1700, 1800, 1900, or 2000 Hz) and/or that are multiples of a current estimate of the pitch frequency of the desired speaker's voice.

In a further example, the first DSP operation includes a blind source separation (BSS) operation. Blind source separation provides a useful way to estimate reverberation in a particular scenario, since it computes a separating filter solution that decorrelates the separated outputs to a degree that mutual information between outputs is minimized. Such an operation is adaptive such that it may continue to reliably separate energy of a directional component as the emitting source moves over time.

Instead of beaming into a desired source as in traditional beamforming techniques, a BSS operation may be designed to generate a beam towards a desired source by beaming out other competing directions. The residual signal may be obtained from a noise or “residual” output of the BSS operation, from which the energy of the directional component is separated (i.e., as opposed to the noisy signal output, into which the energy of the directional component is separated).

It may be desirable to configure the first DSP operation to use a constrained BSS approach to iteratively shape beampatterns in each individual frequency bin and thus to trade off correlated noise against uncorrelated noise and sidelobes against the main beam. To achieve such a result, it may be desirable to regularize the converged beams to unity gain in the desired look direction using a normalization procedure over all look angles. It may also be desirable to use a tuning matrix to directly control the depth and beamwidth of enforced nullbeams during the iteration process per frequency bin in each nullbeam direction.

As with an MVDR design, a BSS design alone may provide insufficient discrimination between the front and back of the microphone array. Consequently, for applications in which it is desirable for the BSS operation to discriminate between sources in front of the microphone array and sources behind it, it may be desirable to implement the array to include at least one microphone facing away from the others, which may be used to indicate sources from behind.

To reduce convergence time, a BSS operation is typically initialized with a set of initial conditions that indicate an estimated direction of the directional component. The initial conditions may be obtained from a beamformer (e.g., an MVDR beamformer) and/or by training the device on recordings of one or more directional sources obtained using the microphone array. For example, the microphone array may be used to record signals from an array of one or more loudspeakers to acquire training data. If it is desired to generate beams toward specific look directions, loudspeakers may be placed at those angles with respect to the array. The beamwidth of the resulting beam may be determined by the proximity of interfering loudspeakers, as the constrained BSS rule may seek to null out competing sources and thus may result in a more or less narrow residual beam determined by the relative angular distance of interfering loudspeakers.

Beamwidths can be influenced by using loudspeakers with different surfaces and curvature, which spread the sound in space according to their geometry. A number of source signals less than or equal to the number of microphones can be used to shape these responses. Different sound files played back by the loudspeakers may be used to create different frequency content. If loudspeakers contain different frequency content, the reproduced signal can be equalized before reproduction to compensate for frequency loss in certain bands.

A BSS operation may be directionally constrained such that, during a particular time interval, the operation separates only energy that arrives from a particular direction. Alternatively, such a constraint may be relaxed to some degree to allow the BSS operation, during a particular time interval, to separate energy arriving from somewhat different directions at different frequencies, which may produce better separation performance in real-world conditions.

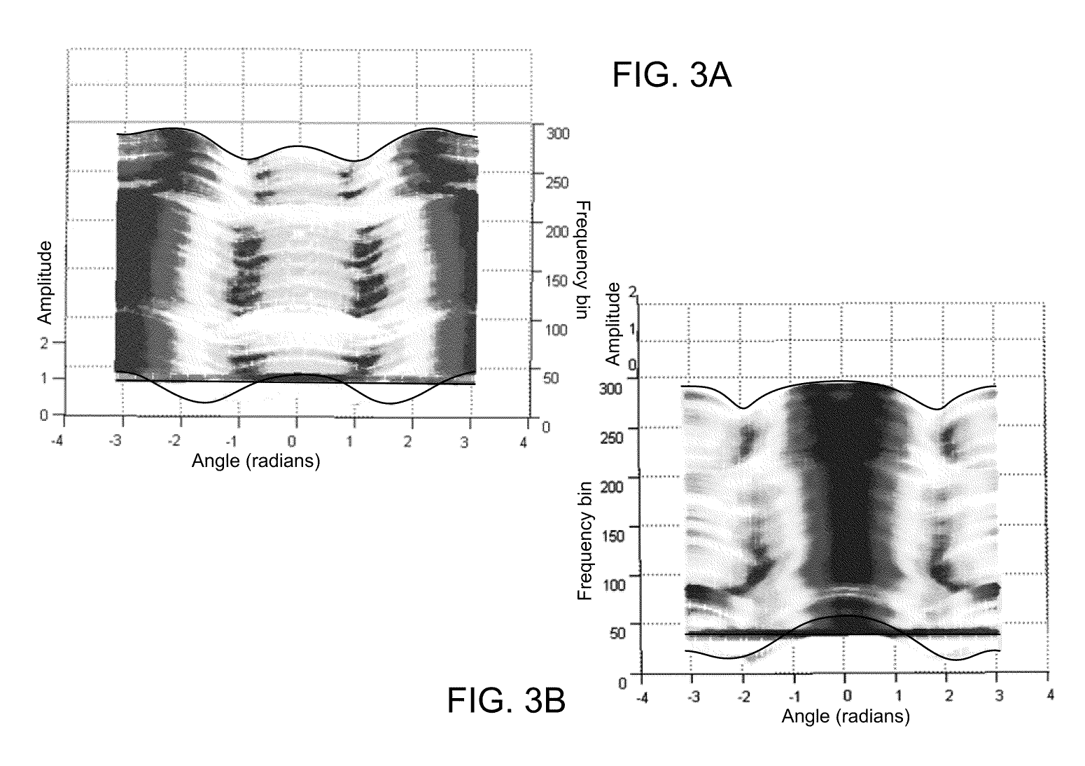

FIGS. 3A and 3B show examples of null beams generated using BSS for different spatial configurations of the sound source (e.g., the user's mouth) relative to the microphone array. For FIG. 3A, the desired sound source is at thirty degrees relative to the array axis, and for FIG. 3B, the desired source is at 120 degrees relative to the array axis. In both of these examples, the frequency range is from zero to four kilohertz, and gain from low to high is indicated by brightness from dark to light. Contour lines are added in each figure at the highest frequency and at a lower frequency to aid comprehension.

While the first DSP operation performed in task T100 may create a sufficiently sharp null beam toward the desired source, this spatial direction may not be very well defined in all frequency bands, especially the low-frequency band (e.g., due to reverberation accumulating in the band). As noted above, directionally selective processing operations are typically less effective at low frequencies, especially for devices having small form factors such that the width of the microphone array is much smaller than the wavelengths of the low-frequency components. Consequently, the first DSP operation performed in task T100 may be effective to remove reverberation of the directional component from middle- and high-frequency bands of the first signal, but may be less effective for removing low-frequency reverberation of the directional component.

Because the residual signal produced by task T100 contains less of the structure of the desired speech signal, an inverse filter trained on this residual signal is less likely to invert the speech formant structure. Consequently, applying the trained inverse filter to the recorded or enhanced signals may be expected to produce high-quality dereverberation without creating artificial speech effects. Suppressing the directional component from the residual signal also enables estimation of the inverse room impulse response function without simultaneous estimation of the directional component, which may enable more efficient computation of the inverse filter response function as compared to traditional inverse filtering approaches.

Task T200 uses information from the residual signal obtained in task T100 to calculate an inverse of the room-response transfer function (also called the “room impulse response function”) F(z). We assume that the recorded signal Y(z) (e.g., the multichannel signal) may be modeled as the sum of a direct-path instance of a desired directional signal S(z) (e.g., a speech signal emitted from the user's mouth) and a reverberated instance of directional signal S(z):

Y(z)=S(z)+S(z)F(z)=S(z)(1+F(z)).

This model may be rearranged to express directional signal S(z) in terms of recorded signal Y(z):

$$S ( z ) = \frac{1}{F ( z ) + 1} Y ( z ) .$$

We also assume that room-response transfer function F(z) can be modeled as an all-pole filter 1/C(z), such that the inverse filter C(z) is a finite-impulse-response (FIR) filter:

$$C ( z ) = 1 + {\sum }_{i = 1}^{q} {c}_{i} {z}^{- 1} .$$

These two models are combined to obtain the following expression for the desired signal S(z):

$$S ( z ) = \frac{C ( z )}{C ( z ) + 1} Y ( z ) .$$

In the absence of any reverberation (i.e., when all of the filter coefficients cᵢ are equal to zero), the functions C(z) and F(z) are each equal to one. In the expression above, this condition produces the result S(z)=Y(z)/2. Consequently, it may be desirable to include a normalization factor of two to obtain a model of speech signal S(z), in terms of recorded signal Y(z) and inverse filter C(z), such as the following:

$$S ( z ) = \frac{2 C ( z )}{C ( z ) + 1} Y ( z ) .$$

In one example, task T200 is configured to calculate the filter coefficients cᵢ of inverse filter C(z) by fitting an autoregressive model to the computed residual. Such a model may be expressed, for example, as C(z)r(t)=e(t), where r(t) denotes the computed residual signal in the time-domain and e(t) denotes a white noise sequence. This model may also be expressed as

$$r [ t ] - {\sum }_{i = 1}^{q} {c}_{i} r [ t - i ] = e [ t ] ,$$

where the notation “a[b]” indicates the value of time-domain sequence a at time b and the filter coefficients cᵢ are the parameters of the model. The order q of the model may be fixed or adaptive.

Task T200 may be configured to compute the parameters cᵢ of such an autoregressive model using any suitable method. In one example, task T200 performs a least-squares minimization operation on the model (i.e., to minimize the energy of the error e(t)). Other methods that may be used to calculate the model parameters cᵢ include the forward-backward approach, the Yule-Walker method, and the Burg method.

In order to obtain a nonzero C(z), task T200 may be configured to assume a distribution function for the error e(t). For example, e(t) may be assumed to be distributed according to a maximum likelihood function. It may be desirable to configure task T200 to constrain e(t) to be a sparse impulse train (e.g., a series of delta functions that includes as few impulses as possible, or as many zeros as possible).

The model parameters cᵢ may be considered to define a whitening filter that is learned on the residual, and the error e(t) may be considered as the hypothetical excitation signal which gave rise to the residual r(t). In this context, the process of computing filter C(z) is similar to the process of finding the excitation vector in LPC speech formant structure modeling. Consequently, it may be possible to solve for the filter coefficients cᵢ using a hardware or firmware module that is used at another time for LPC analysis. Because the residual signal was computed by removing the direct-path instance of the speech signal, it may be expected that the model parameter estimation operation will estimate the poles of the room transfer function F(z) without trying to invert the speech formant structure.

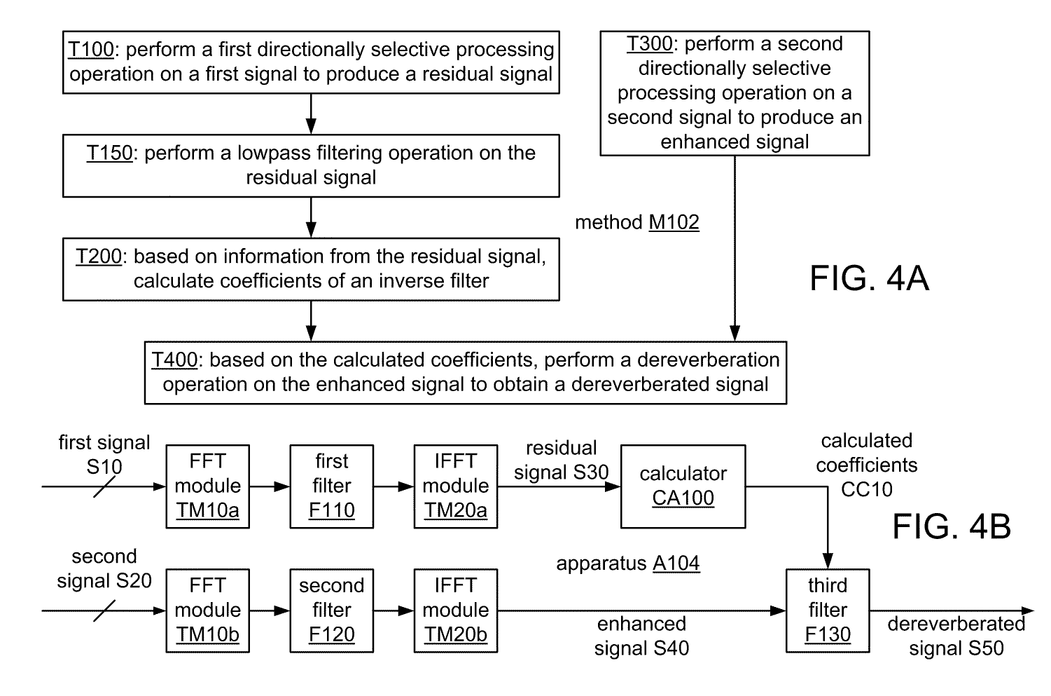

The low-frequency components of the residual signal produced by task T100 tend to include most of the reverberation energy of the directional component. It may be desired to configure an implementation of method M100 to further reduce the amount of mid- and/or high-frequency energy in the residual signal. FIG. 4A shows an example of such an implementation M102 of method M100 that includes a task T150. Task T150 performs a lowpass filtering operation on the residual signal upstream of task T200, such that the filter coefficients calculated in task T200 are based on this filtered residual. In a related alternative implementation of method M100, the first directionally selective processing operation performed in task T100 includes a lowpass filtering operation. In either case, it may be desirable for the lowpass filtering operation to have a cutoff frequency of, e.g., 500, 600, 700, 800, 900, or 1000 Hz.

Task T300 performs a second directionally selective processing operation, on a second signal, to produce an enhanced signal. The second signal includes at least two channels of the multichannel signal, and the second DSP operation produces the enhanced signal by increasing the energy of the directional component in the second signal relative to the total energy of the second signal. The second DSP operation may be configured to increase the relative energy of the directional component by applying a positive gain to the directional component and/or by applying a negative gain to one or more other components of the second signal. The second DSP operation may be configured to execute in the time domain or in a transform domain (e.g., the FFT or DCT domain or another frequency domain).

In one example, the second DSP operation includes a beamforming operation. In this case, the enhanced signal is obtained by computing a beam in the direction of arrival of the directional component (e.g., the direction of the speaker's mouth relative to the microphone array producing the second signal). The beamforming operation, which may be fixed and/or adaptive, may be implemented using any of the beamforming examples mentioned above with reference to task T100. Task T300 may also be configured to select the beam from among a plurality of beams directed in different specified directions (e.g., according to the beam currently producing the highest energy or SNR). In another example, task T300 is configured to select a beam direction using a source localization method, such as the multiple signal classification (MUSIC) algorithm.

In general, a traditional approach such as a delay-and-sum or MVDR beamformer may be used to design one or more beampatterns based on free-field models where the beamformer output energy is minimized with a constrained look direction energy equal to unity. Closed-form MVDR techniques, for example, may be used to design beampatterns based on a given look direction, the inter-microphone distance, and a noise cross-correlation matrix. Typically the resulting designs encompass undesired sidelobes, which may be traded off against the main beam by frequency-dependent diagonal loading of the noise cross-correlation matrix. It may be desirable to use special constrained MVDR cost functions solved by linear programming techniques, which may provide better control over the tradeoff between main beamwidth and sidelobe magnitude. For applications in which it is desirable for the first or second DSP operation to discriminate between sources in front of the microphone array and sources behind it, it may be desirable to implement the array to include at least one microphone facing away from the others that may be used to indicate sources from behind, as an MVDR design alone may provide insufficient discrimination between the front and back of a microphone array.

In another example, the second DSP operation includes applying a gain to a frequency component of the second signal that is based on a difference between the phases of the frequency component in different channels of the second signal. Such an operation, which may be implemented using any of the phase-difference-based examples mentioned above with reference to task T100, may include calculating, for each of a plurality of different frequency components of the second signal, the difference between the corresponding phases of the frequency component in different channels of the second signal, and applying different gains to the frequency components based on the calculated phase differences. Additional information regarding phase-difference-based methods and structures that may be used to implement the first and/or second DSP operations (e.g., first filter F110 and/or second filter F120) is found, for example, in U.S. patent application Ser. No. ______ (Attorney Docket No. 090155, entitled “SYSTEMS, METHODS, APPARATUS, AND COMPUTER-READABLE MEDIA FOR COHERENCE DETECTION,” filed Oct. 23, 2009) and U.S. patent application Ser. No. ______ (Attorney Docket No. 091561, entitled “SYSTEMS, METHODS, APPARATUS, AND COMPUTER-READABLE MEDIA FOR PHASE-BASED PROCESSING OF MULTICHANNEL SIGNAL,” filed Jun. 8, 2010). Such methods include, for example, subband gain control based on phase differences, front-to-back discrimination based on signals from microphones along different array axes, source localization based on coherence within spatial sectors, and complementary masking to mask energy from a directional source (e.g., for residual signal calculation).

In a third example, the second DSP operation includes a blind source separation (BSS) operation, which may be implemented, initialized, and/or constrained using any of the BSS examples mentioned above with reference to task T100. Additional information regarding BSS techniques and structures that may be used to implement the first and/or second DSP operations (e.g., first filter F110 and/or second filter F120) is found, for example, in U.S. Publ. Pat. Appl. No. 2009/0022336 (Visser et al., entitled “SYSTEMS, METHODS, AND APPARATUS FOR SIGNAL SEPARATION,” published Jan. 22, 2009) and U.S. Publ. Pat. Appl. No. 2009/0164212 (Chan et al., entitled “SYSTEMS, METHODS, AND APPARATUS FOR MULTI-MICROPHONE BASED SPEECH ENHANCEMENT,” published Jun. 25, 2009).

In a fourth example, a BSS operation is used to implement both of tasks T100 and T300. In this case, the residual signal is produced at one output of the BSS operation and the enhanced signal is produced at another output of the BSS operation.

Either of the first and second DSP operations may also be implemented to distinguish signal direction based on a relation between the signal levels in each channel of the input signal to the operation (e.g., a ratio of linear levels, or a difference of logarithmic levels, of the channels of the first or second signal). Such a level-based (e.g., gain- or energy-based) operation may be configured to indicate a current direction of the signal, of each of a plurality of subbands of the signal, or of each of a plurality of frequency components of the signal. In this case, it may be desired for the gain responses of the microphone channels (in particular, the gain responses of the microphones) to be well-calibrated with respect to each other.

As noted above, directionally selective processing operations are typically less effective at low frequencies. Consequently, while the second DSP operation performed in task T300 may effectively dereverberate middle and high frequencies of the desired signal, this operation is less likely to be effective at the low frequencies which may be expected to contain most of the reverberation energy.

A loss of directivity of a beamforming, BSS or masking operation is typically manifested as an increase in the width of the mainlobe of the gain response as frequency decreases. The width of the mainlobe may be taken, for example, as the angle between the points at which the gain response drops three decibels from the maximum. It may be desired to describe a loss of directivity of the first and/or second DSP operation as a decrease, as frequency decreases, in the absolute difference between the minimum and maximum gain responses of the operation at a particular frequency. For example, this absolute difference may be expected to be greater over a middle- and/or high-frequency range (e.g., from two to three kHz) than over a low-frequency range (e.g., from three hundred to four hundred Hertz).

Alternatively, it may be desired to describe a loss of directivity of the first and/or second DSP operation as a decrease in the absolute difference between the minimum and maximum gain responses of the operation, with respect to direction, as frequency decreases. For example, this absolute difference may be expected to be greater over a middle- and/or high-frequency range (e.g., from two to three kHz) than over a low-frequency range (e.g., from three hundred to four hundred Hertz). Alternatively, the average, over a middle- and/or high-frequency range (e.g., from two to three kHz), of this absolute difference at each frequency component in the range may be expected to be greater than the average, over a low-frequency range (e.g., from three hundred to four hundred Hertz), of this absolute difference at each frequency component in the range.

Task T400 performs a dereverberation operation on the enhanced signal to produce a dereverberated signal. The dereverberation operation is based on the calculated filter coefficients cᵢ and task T400 may be configured to perform the dereverberation operation in the time domain or in a transform domain (e.g., the FFT or DCT domain or another frequency domain). In one example, task T400 is configured to perform the dereverberation operation according to an expression such as

$$D ( z ) = \frac{2 C ( z )}{C ( z ) + 1} G ( z ) ,$$

where G(z) indicates the enhanced signal S40 and D(z) indicates the dereverberated signal S50. Such an operation may also be expressed as the time-domain difference equation

$$d [ t ] = g [ t ] + {\sum }_{i = 1}^{q} {c}_{i} ( g [ t - i ] - 0.5 d [ t - i ] ) ,$$

where d and g indicate dereverberated signal S50 and enhanced signal S40, respectively, in the time domain.

As noted above, the first DSP operation performed in task T100 may be effective to remove reverberation of the directional component from middle- and high-frequency bands of the first signal. Consequently, the inverse filter calculation performed in task T200 may be based primarily on low-frequency energy, such that the dereverberation operation performed in task T400 attenuates low frequencies of the enhanced signal more than middle or high frequencies. For example, the gain response of the dereverberation operation performed in task T400 may have an average gain response over a middle- and/or high-frequency range (e.g., between two and three kilohertz) that is greater than (e.g., by at least three, six, nine, twelve, or twenty decibels) the average gain response of the dereverberation operation over a low-frequency range (e.g., between three hundred and four hundred Hertz).

Method M100 may be configured to process the multichannel signal as a series of segments. Typical segment lengths range from about five or ten milliseconds to about forty or fifty milliseconds, and the segments may be overlapping (e.g., with adjacent segments overlapping by 25% or 50%) or nonoverlapping. In one particular example, the multichannel signal is divided into a series of nonoverlapping segments or “frames”, each having a length of ten milliseconds. A segment as processed by method M100 may also be a segment (i.e., a “subframe”) of a larger segment as processed by a different operation, or vice versa.

An adaptive implementation of the first directionally selective processing operation (e.g., an adaptive beamformer or BSS operation) may be configured to perform the adaptation at each frame, or at a less frequent interval (e.g., once every five or ten frames), or in response to some event (e.g., a detected change in the direction of arrival). Such an operation may be configured to perform the adaptation by, for example, updating one or more corresponding sets of filter coefficients. An adaptive implementation of the second directionally selective processing operation (e.g., an adaptive beamformer or BSS operation) may be similarly configured.

Task T200 may be configured to calculate the filter coefficients cᵢ over a frame of residual signal r(t) or over a window of multiple consecutive frames. Task T200 may be configured to select the frames of the residual signal used to calculate the filter coefficients according to a voice activity detection (VAD) operation (e.g., an energy-based VAD operation, or the phase-based coherency measure described above) such that the filter coefficients may be based on segments of the residual signal that include reverberation energy. Task T200 may be configured to update (e.g., to recalculate) the filter coefficients at each frame, or at each active frame; or at a less frequent interval (e.g., once every five or ten frames, or once every five or ten active frames); or in response to some event (e.g., a detected change in the direction of arrival of the directional component).

Updating of the filter coefficients in task T200 may include smoothing the calculated values over time to obtain the filter coefficients. Such a temporal smoothing operation may be performed according to an expression such as the following:

cᵢ[n]=αcᵢ[n−1]+(1−α)cᵢₙ,

where cᵢₙ denotes the calculated value of filter coefficient cᵢ, cᵢ[n−1] denotes the previous value of filter coefficient cᵢ, cᵢ[n−1] denotes the updated value of filter coefficient cᵢ and a denotes a smoothing factor having a value in the range of from zero (i.e., no smoothing) to one (i.e., no updating). Typical values for smoothing factor α include 0.5, 0.6, 0.7, 0.8, and 0.9.

FIG. 2B shows a block diagram of an apparatus A100, according to a general configuration, for processing a multichannel signal that includes a directional component. Apparatus A100 includes a first filter F110 that is configured to perform a first directionally selective processing operation (e.g., as described herein with reference to task T100) on a first signal S10 to produce a residual signal S30. Apparatus A100 also includes a second filter F120 that is configured to perform a second directionally selective processing operation (e.g., as described herein with reference to task T300) on a second signal S20 to produce an enhanced signal S40. First signal S10 includes at least two channels of the multichannel signal, and second signal S20 includes at least two channels of the multichannel signal.

Apparatus A100 also includes a calculator CA100 configured to calculate a plurality of filter coefficients of an inverse filter (e.g., as described herein with reference to task T200), based on information from residual signal S30. Apparatus A100 also includes a third filter F130, based on the calculated plurality of filter coefficients, that is configured to filter enhanced signal S40 (e.g., as described herein with reference to task T400) to produce a dereverberated signal S50.

As noted above, each of the first and second DSP operations may be configured to execute in the time domain or in a transform domain (e.g., the FFT or DCT domain or another frequency domain). FIG. 4B shows a block diagram of an example of an implementation A104 of apparatus A100 that explicitly shows conversion of first and second signals S10 and S20 to the FFT domain upstream of filters F110 and F120 (via transform modules TM10a and TM10b), and subsequent conversion of residual signal S30 and enhanced signal S40 to the time domain downstream of filter F110 and F120 (via inverse transform modules TM20a and TM20b). It is explicitly noted that method M100 and apparatus A100 may also be implemented such that both of the first and second directionally selective processing operations are performed in the time domain, or that the first directionally selective processing operation is performed in the time domain and the second directionally selective processing operation is performed in the transform domain (or vice versa). Further examples include a conversion within one or both of the first and second directionally selective processing operations such that the input and output of the operation are in different domains (e.g., a conversion from the FFT domain to the time domain).

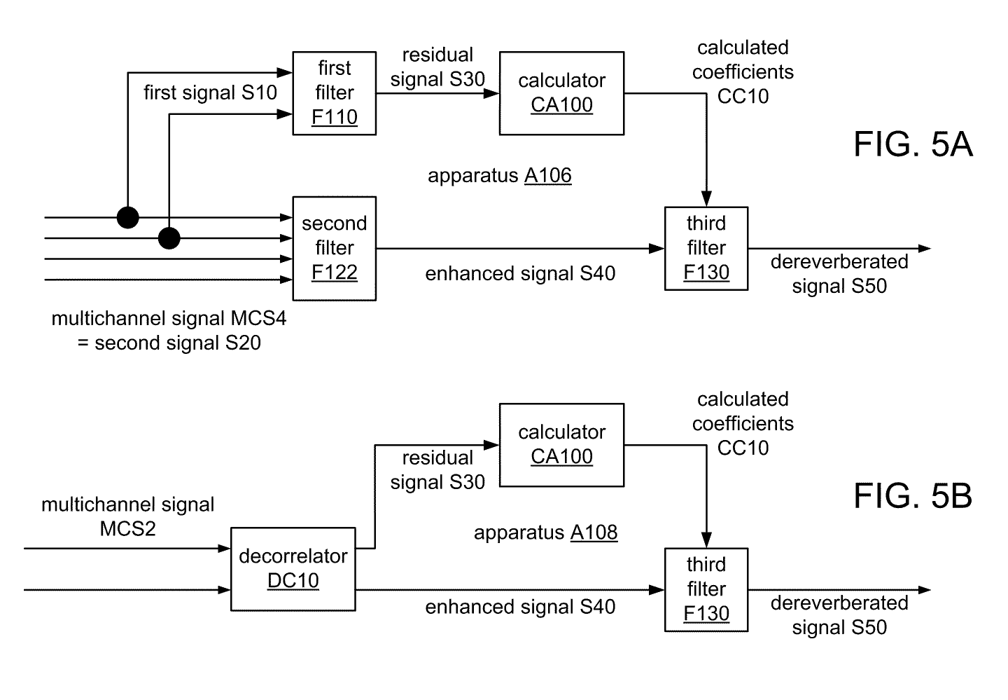

FIG. 5A shows a block diagram of an implementation A106 of apparatus A100. Apparatus A106 includes an implementation F122 of second filter F120 that is configured to receive all four channels of a four-channel implementation MCS4 of the multichannel signal as second signal S20. In one example, apparatus A106 is implemented such that first filter F110 performs a BSS operation and second filter F122 performs a beamforming operation.

FIG. 5B shows a block diagram of an implementation A108 of apparatus A100. Apparatus A108 includes a decorrelator DC10 that is configured to include both of first filter F110 and second filter F120. For example, decorrelator DC10 may be configured to perform a BSS operation (e.g., according to any of the BSS examples described herein) on a two-channel implementation MCS2 of the multichannel signal to produce residual signal S30 at one output (e.g., a noise output) and enhanced signal S40 at another output (e.g., a separated signal output).

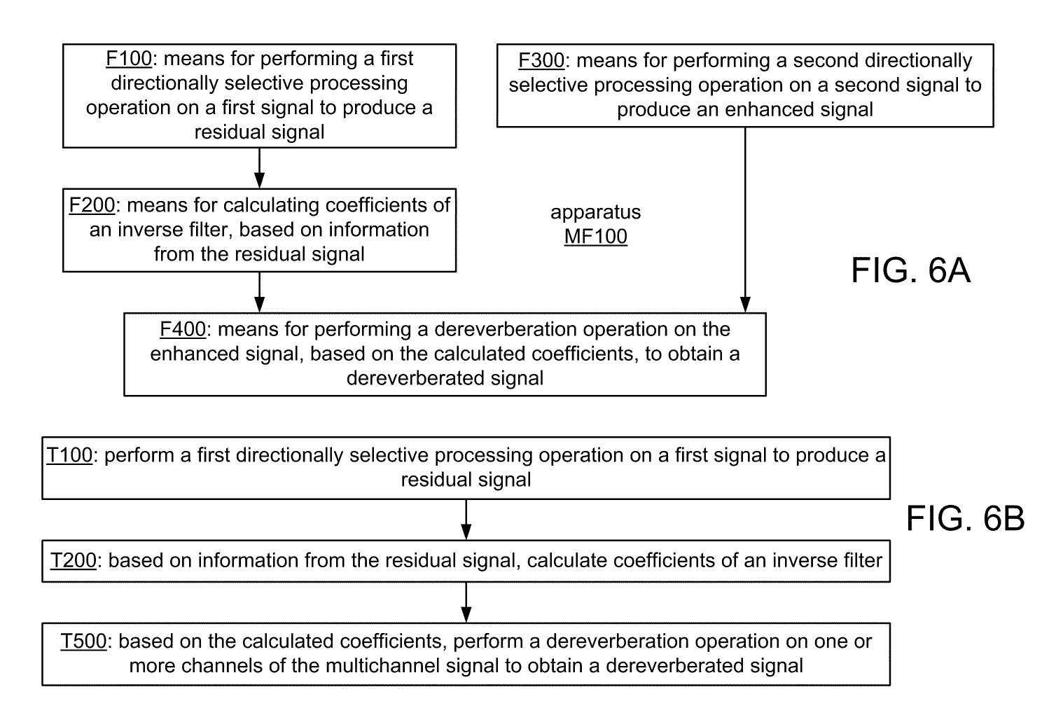

FIG. 6A shows a block diagram of an apparatus MF100, according to a general configuration, for processing a multichannel signal that includes a directional component. Apparatus MF100 includes means F100 for performing a first directionally selective processing operation (e.g., as described herein with reference to task T100) on a first signal to produce a residual signal. Apparatus MF100 also includes means F300 for performing a second directionally selective processing operation (e.g., as described herein with reference to task T300) on a second signal to produce an enhanced signal. The first signal includes at least two channels of the multichannel signal, and the second signal includes at least two channels of the multichannel signal. Apparatus MF100 also includes means F200 for calculating a plurality of filter coefficients of an inverse filter (e.g., as described herein with reference to task T200), based on information from the produced residual signal. Apparatus MF100 also includes means F400 for performing a dereverberation operation, based on the calculated plurality of filter coefficients, on the enhanced signal (e.g., as described herein with reference to task T400) to produce a dereverberated signal.

A multichannel directionally selective processing operation performed in task T300 (alternatively, performed by second filter F120) may be implemented to produce two outputs: a noisy signal output, into which energy of the directional component has been concentrated, and a noise output, which includes energy of other components of the second signal (e.g., other directional components and/or a distributed noise component). Beamforming and BSS operations, for example, are commonly implemented to produce such outputs (e.g., as shown in FIG. 5B). Such an implementation of task T300 or filter F120 may be configured to produce the noisy signal output as the enhanced signal.

Alternatively, it may be desirable in such case to implement the second directionally selective processing operation performed in task T300 (alternatively, performed by second filter F120 or decorrelator DC10) to include a post-processing operation that produces the enhanced signal by using the noise output to further reduce noise in the noisy signal output. Such a post-processing operation (also called a “noise reduction operation”) may be configured, for example, as a Wiener filtering operation on the noisy signal output, based on the spectrum of the noise output. Alternatively, such a noise reduction operation may be configured as a spectral subtraction operation that subtracts an estimated noise spectrum, which is based on the noise output, from the noisy signal output to produce the enhanced signal. Such a noise reduction operation may also be configured as a subband gain control operation based on a spectral subtraction or signal-to-noise-ratio (SNR) based gain rule. At aggressive settings, however, such a subband gain control operation may lead to speech distortion.

Depending on the particular design choice, task T300 (alternatively, second filter F120) may be configured to produce the enhanced signal as a single-channel signal (i.e., as described and illustrated herein) or as a multichannel signal. For a case in which the enhanced signal is a multichannel signal, task T400 may be configured to perform a corresponding instance of the dereverberation operation on each channel. In such case, it is possible to perform a noise reduction operation as described above on one or more of the resulting channels, based on a noise estimate from another one or more of the resulting channels.

It is possible to implement a method of processing the multichannel signal (or a corresponding apparatus) as shown in the flowchart of FIG. 6B, in which a task T500 performs a dereverberation operation as described herein with reference to task T400 on one or more of the channels of the multichannel signal, rather than on an enhanced signal as produced by task T300. In this case, task T300 (or second filter F120) may be omitted or bypassed. Method M100 may be expected to produce a better result than such a method (or corresponding apparatus), however, as the multichannel DSP operation of task T300 may be expected to perform better dereverberation of the directional component in the middle and high frequencies than dereverberation based on an inverse room-response filter.

The range of blind source separation (BSS) algorithms that may be used to implement the first DSP operation performed by task T100 (alternatively, first filter F110) and/or the second DSP operation performed by task T300 (alternatively, second filter F120) includes an approach called frequency-domain ICA or complex ICA, in which the filter coefficient values are computed directly in the frequency domain. Such an approach, which may be implemented using a feedforward filter structure, may include performing an FFT or other transform on the input channels. This ICA technique is designed to calculate an M×M unmixing matrix W(ω) for each frequency bin ω such that the demixed output vectors Y(ω,l)=W(ω)X( ,l) are mutually independent, where X(ω,l) denotes the observed signal for frequency bin ω and window l. The unmixing matrices W(ω) are updated according to a rule that may be expressed as follows:

Wₗ₊ᵣ(ω)=Wₗ(ω)+μ[I− [symbol] Φ(Y(ω,l))Y(ω,l)^{H} [symbol] ]Wₗ(ω) (1)

where Wₗ(ω) denotes the unmixing matrix for frequency bin ω and window l, Y(ω,l) denotes the filter output for frequency bin ω and window l, Wₗ₊ᵣ(ω) denotes the unmixing matrix for frequency bin ω and window (l+r), r is an update rate parameter having an integer value not less than one, μ is a learning rate parameter, I is the identity matrix, Φ denotes an activation function, the superscript H denotes the conjugate transpose operation, and the brackets < > denote the averaging operation in time l=1, . . . , L. In one example, the activation function Φ(Yⱼ(ω,l)) is equal to Yⱼ(ω,l)/|Yⱼ(ω,l)|. Examples of well-known ICA implementations include Infomax, FastICA (available online at www-dot-cis-dot-hut-dot-fi/projects/ica/fastica), and JADE (Joint Approximate Diagonalization of Eigenmatrices).

The beam pattern for each output channel j of such a synthesized beamformer may be obtained from the frequency-domain transfer function Wⱼₘ(i*ω) (where m denotes the input channel, 1<=m<=M) by computing the magnitude plot of the expression

Wⱼₗ(i×ω)D(ω)₁ⱼ+Wⱼ₂(i×ω)D(ω)₂ⱼ+ . . . +W_{jM}(i×ω)D(ω)_{Mj}.

In this expression, D(ω) indicates the directivity matrix for frequency ω such that

D(ω)ᵢⱼ=exp(−i×cos(θⱼ)×pos(i)×ω/c), (2)

where pos(i) denotes the spatial coordinates of the i-th microphone in an array of M microphones, c is the propagation velocity of sound in the medium (e.g., 340 m/s in air), and θⱼ denotes the incident angle of arrival of the j-th source with respect to the axis of the microphone array.

Complex ICA solutions typically suffer from a scaling ambiguity, which may cause a variation in beampattern gain and/or response color as the look direction changes. If the sources are stationary and the variances of the sources are known in all frequency bins, the scaling problem may be solved by adjusting the variances to the known values. However, natural signal sources are dynamic, generally non-stationary, and have unknown variances.

Instead of adjusting the source variances, the scaling problem may be solved by adjusting the learned separating filter matrix. One well-known solution, which is obtained by the minimal distortion principle, scales the learned unmixing matrix according to an expression such as the following.

Wₗ₊ᵣ(ω)←diag(Wₗ₊ᵣ⁻¹(ω)Wₗ₊ᵣ(ω).

It may be desirable to address the scaling problem by creating a unity gain in a desired look direction, which may help to reduce or avoid frequency coloration of a desired speaker's voice. One such approach normalizes each row j of matrix ω by the maximum of the filter response magnitude over all angles:

max_{θj}=[−π,π]|Wⱼ₁(i×ω)D(ω)₁ⱼ+Wⱼ₂(i×ω)D(ω)₂ⱼ+ . . . +W_{jM}(i×ω)D(ω)_{Mj}|.

Another problem with some complex ICA implementations is a loss of coherence among frequency bins that relate to the same source. This loss may lead to a frequency permutation problem in which frequency bins that primarily contain energy from the information source are misassigned to the interference output channel and/or vice versa. Several solutions to this problem may be used.

One response to the permutation problem that may be used is independent vector analysis (IVA), a variation of complex ICA that uses a source prior which models expected dependencies among frequency bins. In this method, the activation function 1 is a multivariate activation function such as the following:

$$Φ ( {Y}_{j} ( ω , l ) ) = \frac{{Y}_{j} ( ω , l )}{{( {\sum }_{ω} {\vert {Y}_{j} ( ω , l ) \vert}^{p} )}^{1 / p}}$$

where p has an integer value greater than or equal to one (e.g., 1, 2, or 3). In this function, the term in the denominator relates to the separated source spectra over all frequency bins.

The BSS algorithm may try to naturally beam out interfering sources, only leaving energy in the desired look direction. After normalization over all frequency bins, such an operation may result in a unity gain in the desired source direction. The BSS algorithm may not yield a perfectly aligned beam in a certain direction. If it is desired to create beamformers with a certain spatial pickup pattern, then sidelobes can be minimized and beamwidths shaped by enforcing nullbeams in particular look directions, whose depth and width can be enforced by specific tuning factors for each frequency bin and for each null beam direction.

It may be desirable to fine-tune the raw beam patterns provided by the BSS algorithm by selectively enforcing sidelobe minimization and/or regularizing the beam pattern in certain look directions. The desired look direction can be obtained, for example, by computing the maximum of the filter spatial response over the array look directions and then enforcing constraints around this maximum look direction.

It may be desirable to enforce beams and/or null beams by adding a regularization term J(ω) based on the directivity matrix D(ω) (as in expression (2) above):

J(ω)=S(ω)∥W(ω)D(ω)−C(ω)∥² (3)

where S(ω) is a tuning matrix for frequency ω and each null beam direction, and C(w) is an M×M diagonal matrix equal to diag(W(ω)*D(ω)) that sets the choice of the desired beam pattern and places nulls at interfering directions for each output channel j. Such regularization may help to control sidelobes. For example, matrix S(ω) may be used to shape the depth of each null beam in a particular direction θⱼ by controlling the amount of enforcement in each null direction at each frequency bin. Such control may be important for trading off the generation of sidelobes against narrow or broad null beams.

Regularization term (3) may be expressed as a constraint on the unmixing matrix update equation with an expression such as the following:

constr(ω)=(dJ/dW)(ω)=μ*S(ω)*2*(W(ω)*D(ω)−C(ω))D(ω)^{H}.

Such a constraint may be implemented by adding such a term to the filter learning rule (e.g., expression (1)), as in the following expression:

W_{constr.l+p}(ω)=Wₗ(ω)+μ[I− [symbol] Φ(Y(ω,l))Y(ω,l)^{H} [symbol] ]Wₗ(ω)+2S(ω)(Wₗ(ω)D(ω)−C(ω))D(ω)^{H}.

The source direction of arrival (DOA) values θⱼ may be determined based on the converged BSS beampatterns to eliminate sidelobes. In order to reduce the sidelobes, which may be prohibitively large for the desired application, it may be desirable to enforce selective null beams. A narrowed beam may be obtained by applying an additional null beam enforced through a specific matrix S(ω) in each frequency bin.

It may be desirable to produce a portable audio sensing device that has an array R100 of two or more microphones configured to receive acoustic signals and an implementation of apparatus A100. Examples of a portable audio sensing device that may be implemented to include such an array and may be used for audio recording and/or voice communications applications include a telephone handset (e.g., a cellular telephone handset); a wired or wireless headset (e.g., a Bluetooth headset); a handheld audio and/or video recorder; a personal media player configured to record audio and/or video content; a personal digital assistant (PDA) or other handheld computing device; and a notebook computer, laptop computer, netbook computer, tablet computer, or other portable computing device. Other examples of audio sensing devices that may be constructed to include instances of array R100 and apparatus A100 and may be used for audio recording and/or voice communications applications include set-top boxes and audio- and/or video-conferencing devices.

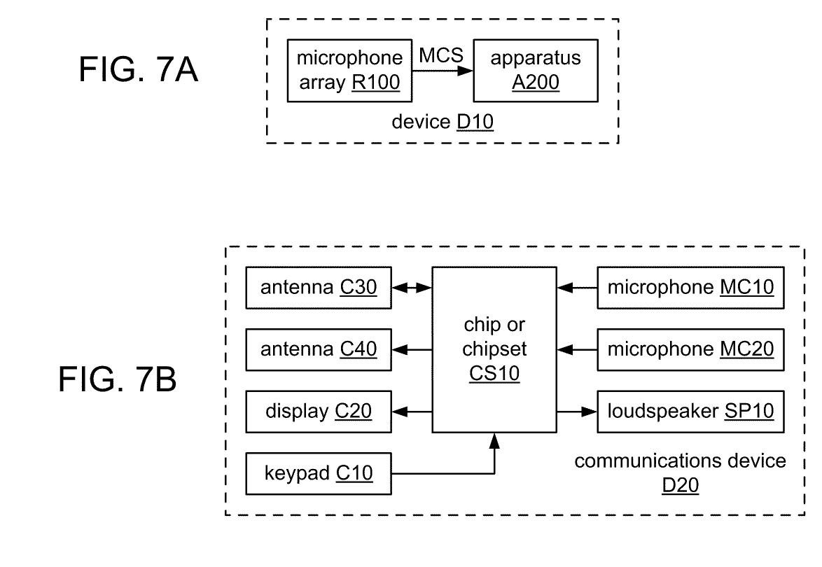

FIG. 7A shows a block diagram of a multimicrophone audio sensing device D10 according to a general configuration. Device D10 includes an instance of any of the implementations of microphone array R100 disclosed herein, and any of the audio sensing devices disclosed herein may be implemented as an instance of device D10. Device D10 also includes an apparatus A200 that is an implementation of apparatus A100 as disclosed herein (e.g., apparatus A100, A104, A106, A108, and/or MF100) and/or is configured to process the multichannel audio signal MCS by performing an implementation of method M100 as disclosed herein (e.g., method M100 or M102). Apparatus A200 may be implemented in hardware and/or in software (e.g., firmware). For example, apparatus A200 may be implemented to execute on a processor of device D10.

FIG. 7B shows a block diagram of a communications device D20 that is an implementation of device D10. Device D20 includes a chip or chipset CS10 (e.g., a mobile station modem (MSM) chipset) that includes apparatus A200. Chip/chipset CS10 may include one or more processors, which may be configured to execute all or part of apparatus A200 (e.g., as instructions). Chip/chipset CS10 may also include processing elements of array R100 (e.g., elements of audio preprocessing stage AP10 as described below). Chip/chipset CS10 includes a receiver, which is configured to receive a radio-frequency (RF) communications signal and to decode and reproduce an audio signal encoded within the RF signal, and a transmitter, which is configured to encode an audio signal that is based on a processed signal produced by apparatus A200 and to transmit an RF communications signal that describes the encoded audio signal. For example, one or more processors of chip/chipset CS10 may be configured to perform a noise reduction operation as described above on one or more channels of the multichannel signal such that the encoded audio signal is based on the noise-reduced signal.

Each microphone of array R100 may have a response that is omnidirectional, bidirectional, or unidirectional (e.g., cardioid). The various types of microphones that may be used in array R100 include (without limitation) piezoelectric microphones, dynamic microphones, and electret microphones. In a device for portable voice communications, such as a handset or headset, the center-to-center spacing between adjacent microphones of array R100 is typically in the range of from about 1.5 cm to about 4.5 cm, although a larger spacing (e.g., up to 10 or 15 cm) is also possible in a device such as a handset or smartphone, and even larger spacings (e.g., up to 20, 25 or 30 cm or more) are possible in a device such as a tablet computer. The microphones of array R100 may be arranged along a line (with uniform or non-uniform microphone spacing) or, alternatively, such that their centers lie at the vertices of a two-dimensional (e.g., triangular) or three-dimensional shape.

It is expressly noted that the microphones may be implemented more generally as transducers sensitive to radiations or emissions other than sound. In one such example, the microphone pair is implemented as a pair of ultrasonic transducers (e.g., transducers sensitive to acoustic frequencies greater than fifteen, twenty, twenty-five, thirty, forty, or fifty kilohertz or more).

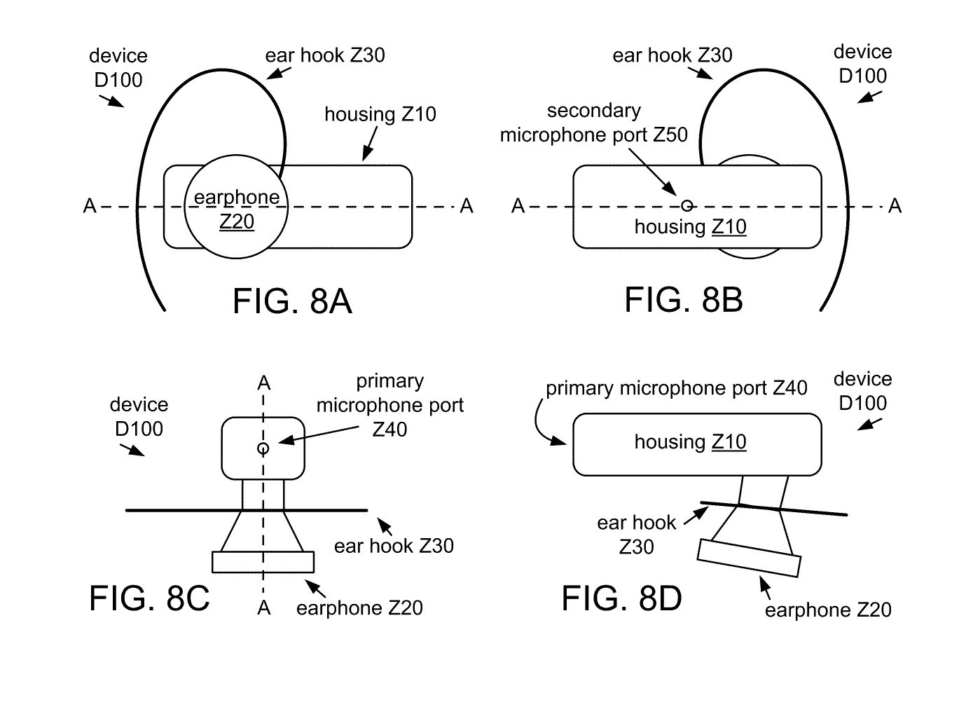

FIGS. 8A to 8D show various views of a portable implementation D100 of multi-microphone audio sensing device D10. Device D100 is a wireless headset that includes a housing Z10 which carries a two-microphone implementation of array R100 and an earphone Z20 that extends from the housing. Such a device may be configured to support half- or full-duplex telephony via communication with a telephone device such as a cellular telephone handset (e.g., using a version of the Bluetooth™ protocol as promulgated by the Bluetooth Special Interest Group, Inc., Bellevue, Wash.). In general, the housing of a headset may be rectangular or otherwise elongated as shown in FIGS. 8A, 8B, and 8D (e.g., shaped like a miniboom) or may be more rounded or even circular. The housing may also enclose a battery and a processor and/or other processing circuitry (e.g., a printed circuit board and components mounted thereon) and may include an electrical port (e.g., a mini-Universal Serial Bus (USB) or other port for battery charging) and user interface features such as one or more button switches and/or LEDs. Typically the length of the housing along its major axis is in the range of from one to three inches.

Typically each microphone of array R100 is mounted within the device behind one or more small holes in the housing that serve as an acoustic port. FIGS. 8B to 8D show the locations of the acoustic port Z40 for the primary microphone of the array of device D100 and the acoustic port Z50 for the secondary microphone of the array of device D100.

A headset may also include a securing device, such as ear hook Z30, which is typically detachable from the headset. An external ear hook may be reversible, for example, to allow the user to configure the headset for use on either ear. Alternatively, the earphone of a headset may be designed as an internal securing device (e.g., an earplug) which may include a removable earpiece to allow different users to use an earpiece of different size (e.g., diameter) for better fit to the outer portion of the particular user's ear canal.

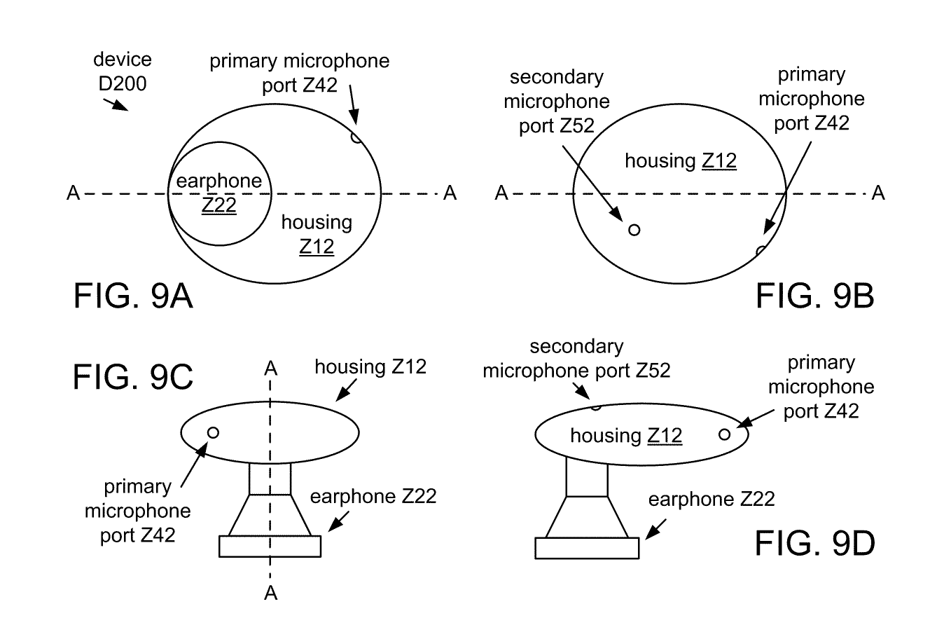

FIGS. 9A to 9D show various views of a portable implementation D200 of multi-microphone audio sensing device D10 that is another example of a wireless headset. Device D200 includes a rounded, elliptical housing Z12 and an earphone Z22 that may be configured as an earplug. FIGS. 9A to 9D also show the locations of the acoustic port Z42 for the primary microphone and the acoustic port Z52 for the secondary microphone of the array of device D200. It is possible that secondary microphone port Z52 may be at least partially occluded (e.g., by a user interface button).

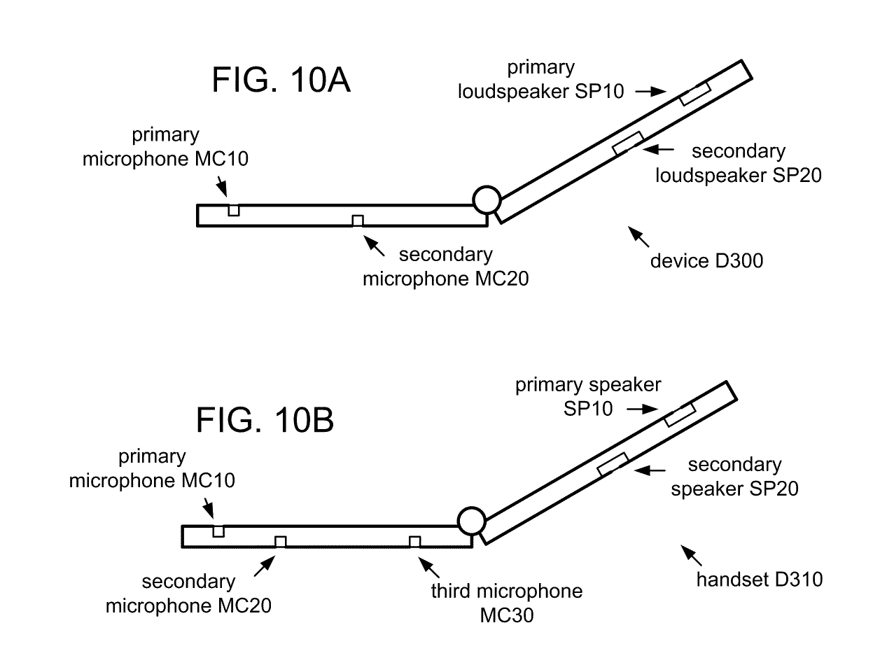

FIG. 10A shows a cross-sectional view (along a central axis) of a portable implementation D300 of multi-microphone audio sensing device D10 that is a communications handset. Device D300 includes an implementation of array R100 having a primary microphone MC10 and a secondary microphone MC20. In this example, device D300 also includes a primary loudspeaker SP10 and a secondary loudspeaker SP20. Such a device may be configured to transmit and receive voice communications data wirelessly via one or more encoding and decoding schemes (also called “codecs”). Examples of such codecs include the Enhanced Variable Rate Codec, as described in the Third Generation Partnership Project 2 (3GPP2) document C.S0014-C, v1.0, entitled “Enhanced Variable Rate Codec, Speech Service Options 3, 68, and 70 for Wideband Spread Spectrum Digital Systems,” February 2007 (available online at www-dot-3gpp-dot-org); the Selectable Mode Vocoder speech codec, as described in the 3GPP2 document C.S0030-0, v3.0, entitled “Selectable Mode Vocoder (SMV) Service Option for Wideband Spread Spectrum Communication Systems,” January 2004 (available online at www-dot-3gpp-dot-org); the Adaptive Multi Rate (AMR) speech codec, as described in the document ETSI TS 126 092 V6.0.0 (European Telecommunications Standards Institute (ETSI), Sophia Antipolis Cedex, FR, December 2004); and the AMR Wideband speech codec, as described in the document ETSI TS 126 192 V6.0.0 (ETSI, December 2004).

In the example of FIG. 10A, handset D300 is a clamshell-type cellular telephone handset (also called a “flip” handset). Other configurations of such a multi-microphone communications handset include bar-type, slider-type, and touchscreen telephone handsets, and device D10 may be implemented according to any of these formats. FIG. 10B shows a cross-sectional view of an implementation D310 of device D300 that includes a three-microphone implementation of array R100 that includes a third microphone MC30.

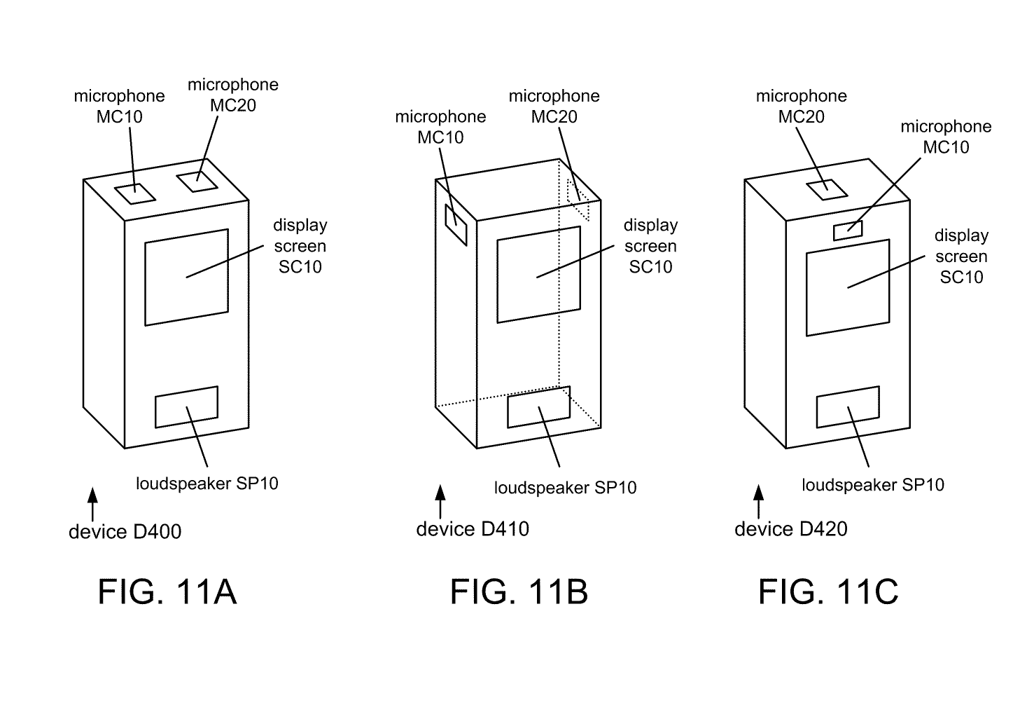

FIG. 11A shows a diagram of a portable implementation D400 of multi-microphone audio sensing device D10 that is a media player. Such a device may be configured for playback of compressed audio or audiovisual information, such as a file or stream encoded according to a standard compression format (e.g., Moving Pictures Experts Group (MPEG)-1 Audio Layer 3 (MP3), MPEG-4 Part 14 (MP4), a version of Windows Media Audio/Video (WMA/WMV) (Microsoft Corp., Redmond, Wash.), Advanced Audio Coding (AAC), International Telecommunication Union (ITU)-T H.264, or the like). Device D400 includes a display screen SC10 and a loudspeaker SP10 disposed at the front face of the device, and microphones MC10 and MC20 of array R100 are disposed at the same face of the device (e.g., on opposite sides of the top face as in this example, or on opposite sides of the front face). FIG. 11B shows another implementation D410 of device D400 in which microphones MC10 and MC20 are disposed at opposite faces of the device, and FIG. 11C shows a further implementation D420 of device D400 in which microphones MC10 and MC20 are disposed at adjacent faces of the device. A media player may also be designed such that the longer axis is horizontal during an intended use.

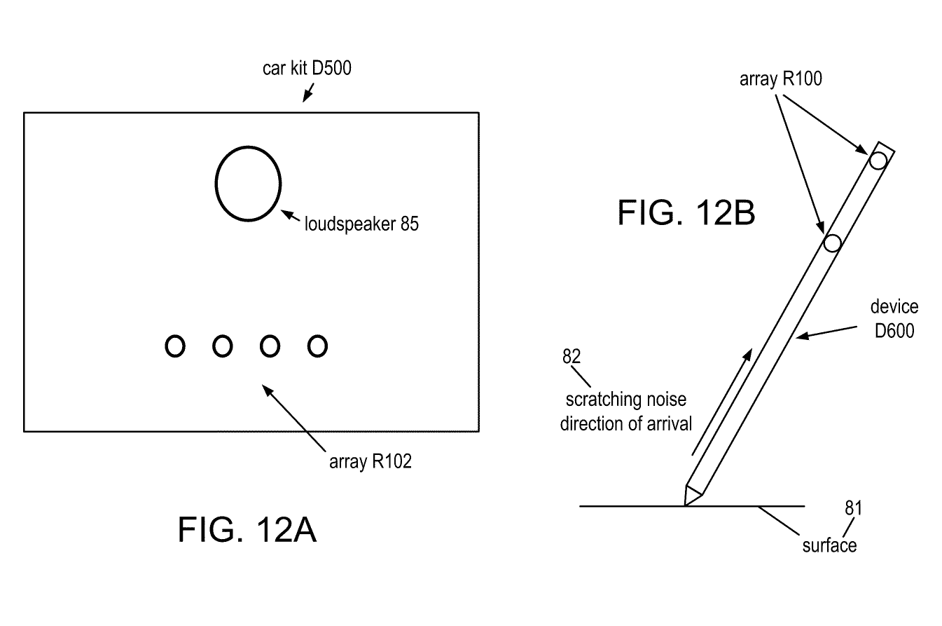

FIG. 12A shows a diagram of an implementation D500 of multi-microphone audio sensing device D10 that is a hands-free car kit. Such a device may be configured to be installed in or on or removably fixed to the dashboard, the windshield, the rear-view mirror, a visor, or another interior surface of a vehicle. For example, it may be desirable to position such a device in front of the front-seat occupants and between the driver's and passenger's visors (e.g., in or on the rearview mirror). Device D500 includes a loudspeaker 85 and an implementation of array R100. In this particular example, device D500 includes a four-microphone implementation R102 of array R100. Such a device may be configured to transmit and receive voice communications data wirelessly via one or more codecs, such as the examples listed above. Alternatively or additionally, such a device may be configured to support half- or full-duplex telephony via communication with a telephone device such as a cellular telephone handset (e.g., using a version of the Bluetooth™ protocol as described above).

FIG. 12B shows a diagram of a portable implementation D600 of multi-microphone audio sensing device D10 that is a stylus or writing device (e.g., a pen or pencil). Device D600 includes an implementation of array R100. Such a device may be configured to transmit and receive voice communications data wirelessly via one or more codecs, such as the examples listed above. Alternatively or additionally, such a device may be configured to support half- or full-duplex telephony via communication with a device such as a cellular telephone handset and/or a wireless headset (e.g., using a version of the Bluetooth™ protocol as described above). Device D600 may include one or more processors configured to perform a spatially selective processing operation to reduce the level of a scratching noise 82, which may result from a movement of the tip of device D600 across a drawing surface 81 (e.g., a sheet of paper), in a signal produced by array R100.

One example of a nonlinear four-microphone implementation of array R100 includes three microphones in a line, with five centimeters spacing between the center microphone and each of the outer microphones, and another microphone positioned four centimeters above the line and closer to the center microphone than to either outer microphone. One example of an application for such an array is an alternate implementation of hands-free carkit D500.

The class of portable computing devices currently includes devices having names such as laptop computers, notebook computers, netbook computers, ultra-portable computers, tablet computers, mobile Internet devices, smartbooks, and smartphones. Such a device may have a top panel that includes a display screen and a bottom panel that may include a keyboard, wherein the two panels may be connected in a clamshell or other hinged relationship.

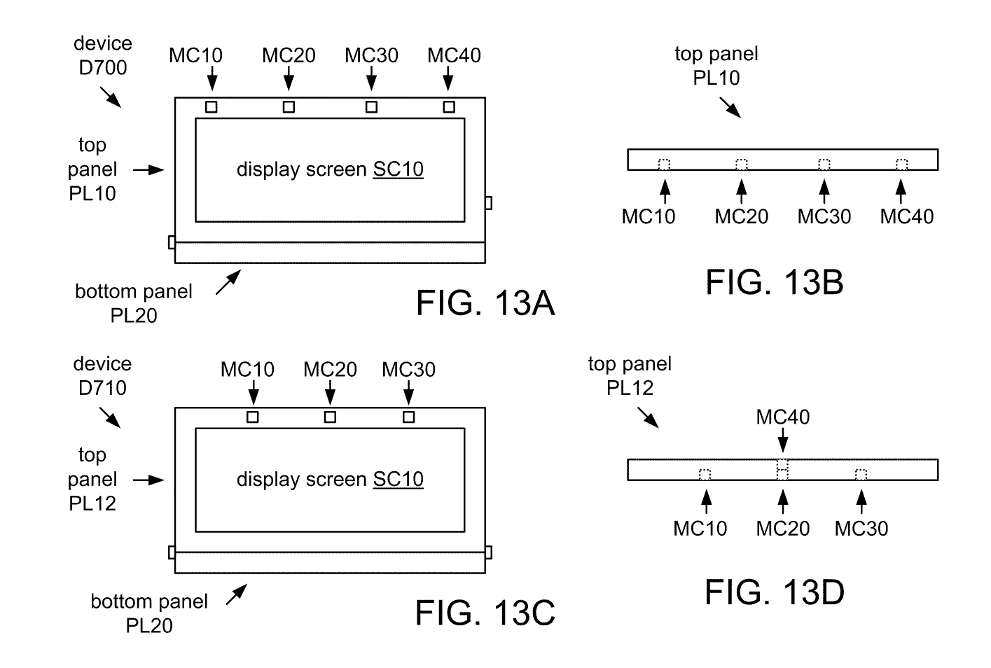

FIG. 13A shows a front view of an example of such a portable computing implementation D700 of device D10. Device D700 includes an implementation of array R100 having four microphones MC10, MC20, MC30, MC40 arranged in a linear array on top panel PL10 above display screen SC10. FIG. 13B shows a top view of top panel PL10 that shows the positions of the four microphones in another dimension. FIG. 13C shows a front view of another example of such a portable computing device D710 that includes an implementation of array R100 in which four microphones MC10, MC20, MC30, MC40 are arranged in a nonlinear fashion on top panel PL12 above display screen SC10. FIG. 13D shows a top view of top panel PL12 that shows the positions of the four microphones in another dimension, with microphones MC10, MC20, and MC30 disposed at the front face of the panel and microphone MC40 disposed at the back face of the panel.

It may be expected that the user may move from side to side in front of such a device D700 or D710, toward and away from the device, and/or even around the device (e.g., from the front of the device to the back) during use. It may be desirable to implement device D10 within such a device to provide a suitable tradeoff between preservation of near-field speech and attenuation of far-field interference, and/or to provide nonlinear signal attenuation in undesired directions. It may be desirable to select a linear microphone configuration for minimal voice distortion, or a nonlinear microphone configuration for better noise reduction.

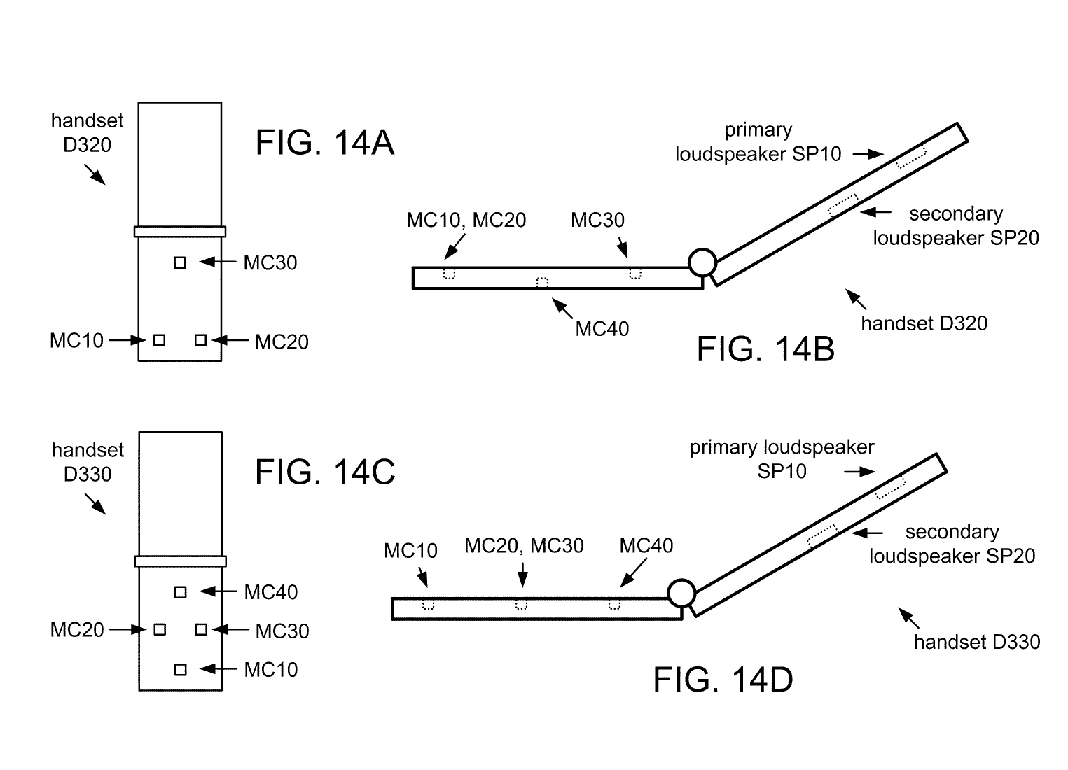

In another example of a four-microphone instance of array R100, the microphones are arranged in a roughly tetrahedral configuration such that one microphone is positioned behind (e.g., about one centimeter behind) a triangle whose vertices are defined by the positions of the other three microphones, which are spaced about three centimeters apart. Potential applications for such an array include a handset operating in a speakerphone mode, for which the expected distance between the speaker's mouth and the array is about twenty to thirty centimeters. FIG. 14A shows a front view of an implementation D320 of handset D300 that includes such an implementation of array R100 in which four microphones MC10, MC20, MC30, MC40 are arranged in a roughly tetrahedral configuration. FIG. 14B shows a side view of handset D320 that shows the positions of microphones MC10, MC20, MC30, and MC40 within the handset.

Another example of a four-microphone instance of array R100 for a handset application includes three microphones at the front face of the handset (e.g., near the 1, 7, and 9 positions of the keypad) and one microphone at the back face (e.g., behind the 7 or 9 position of the keypad). FIG. 14C shows a front view of an implementation D330 of handset D300 that includes such an implementation of array R100 in which four microphones MC10, MC20, MC30, MC40 are arranged in a “star” configuration. FIG. 14D shows a side view of handset D330 that shows the positions of microphones MC10, MC20, MC30, and MC40 within the handset. Other examples of device D10 include touchscreen implementations of handset D320 and D330 (e.g., as flat, non-folding slabs, such as the iPhone (Apple Inc., Cupertino, Calif.), HD2 (HTC, Taiwan, ROC) or CLIQ (Motorola, Inc., Schaumberg, Ill.)) in which the microphones are arranged in similar fashion at the periphery of the touchscreen.

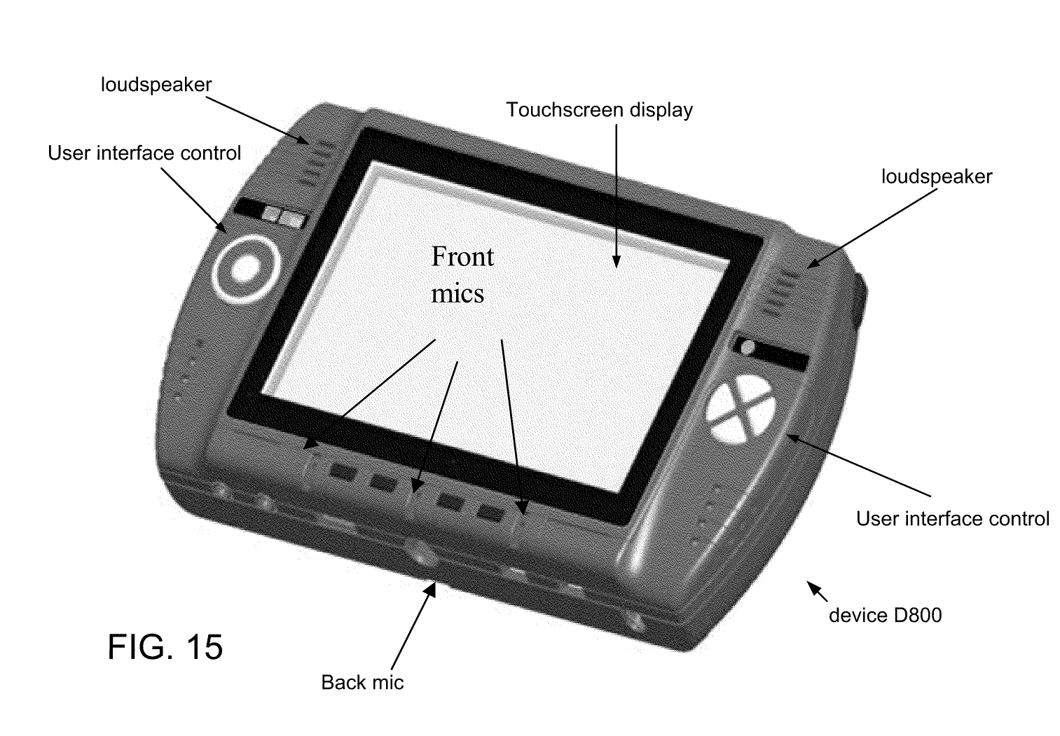

FIG. 15 shows a diagram of a portable implementation D800 of multimicrophone audio sensing device D10 for handheld applications. Device D800 includes a touchscreen display, a user interface selection control (left side), a user interface navigation control (right side), two loudspeakers, and an implementation of array R100 that includes three front microphones and a back microphone. Each of the user interface controls may be implemented using one or more of pushbuttons, trackballs, click-wheels, touchpads, joysticks and/or other pointing devices, etc. A typical size of device D800, which may be used in a browse-talk mode or a game-play mode, is about fifteen centimeters by twenty centimeters. Device D10 may be similarly implemented as a tablet computer that includes a touchscreen display on a top surface (e.g., a “slate,” such as the iPad (Apple, Inc.), Slate (Hewlett-Packard Co., Palo Alto, Calif.) or Streak (Dell Inc., Round Rock, Tex.)), with microphones of array R100 being disposed within the margin of the top surface and/or at one or more side surfaces of the tablet computer.

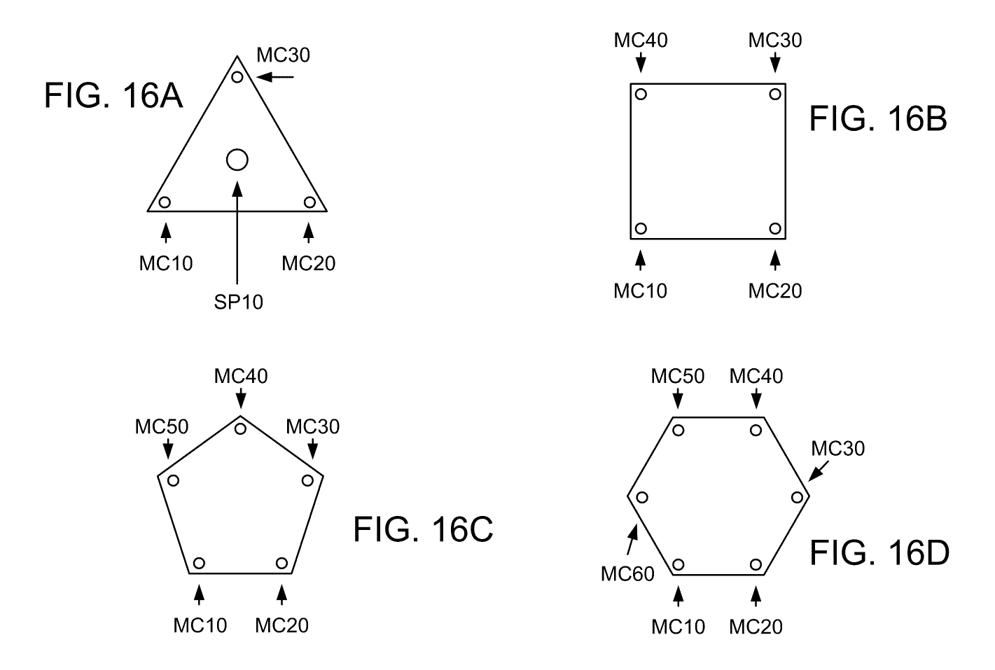

Reverberation energy within the multichannel recorded signal tends to increase as the distance between the desired source and array R100 increases. Another application in which it may be desirable to practice method M100 is audio- and/or video-conferencing. FIGS. 16A-D show top views of several examples of conferencing implementations of device D10. FIG. 16A includes a three-microphone implementation of array R100 (microphones MC10, MC20, and MC30). FIG. 16B includes a four-microphone implementation of array R100 (microphones MC10, MC20, MC30, and MC40). FIG. 16C includes a five-microphone implementation of array R100 (microphones MC10, MC20, MC30, MC40, and MC50). FIG. 16D includes a six-microphone implementation of array R100 (microphones MC10, MC20, MC30, MC40, MC50, and MC60). It may be desirable to position each of the microphones of array R100 at a corresponding vertex of a regular polygon. A loudspeaker SP10 for reproduction of the far-end audio signal may be included within the device (e.g., as shown in FIG. 16A), and/or such a loudspeaker may be located separately from the device (e.g., to reduce acoustic feedback).

It may be desirable for a conferencing implementation of device D10 to perform a separate instance of an implementation of method M100 for each microphone pair, or at least for each active microphone pair (e.g., to separately dereverberate each voice of more than one near-end speaker). In such case, it may also be desirable for the device to combine (e.g., to mix) the various dereverberated speech signals before transmission to the far-end.

In another example of a conferencing application of device D100, a horizontal linear implementation of array R100 is included within the front panel of a television or set-top box. Such a device may be configured to support telephone communications by locating and dereverberating a near-end source signal from a person speaking within the area in front of and from a position about one to three or four meters away from the array (e.g., a viewer watching the television). It is expressly disclosed that applicability of systems, methods, and apparatus disclosed herein is not limited to the particular examples shown in FIGS. 8A to 16D.

During the operation of a multi-microphone audio sensing device (e.g., device D100, D200, D300, D400, D500, or D600), array R100 produces a multichannel signal in which each channel is based on the response of a corresponding one of the microphones to the acoustic environment. One microphone may receive a particular sound more directly than another microphone, such that the corresponding channels differ from one another to provide collectively a more complete representation of the acoustic environment than can be captured using a single microphone.

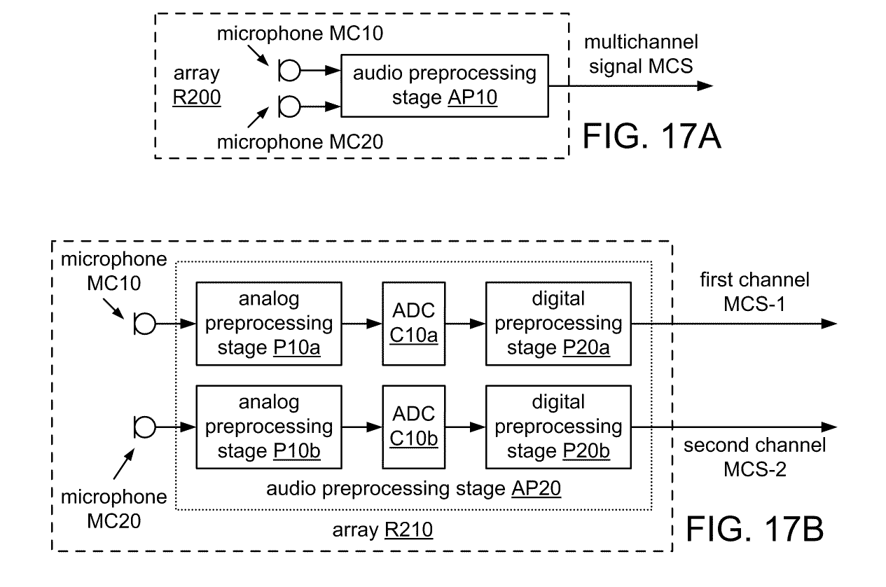

It may be desirable for array R100 to perform one or more processing operations on the signals produced by the microphones to produce the multichannel signal MCS. FIG. 17A shows a block diagram of an implementation R200 of array R100 that includes an audio preprocessing stage AP10 configured to perform one or more such operations, which may include (without limitation) impedance matching, analog-to-digital conversion, gain control, and/or filtering in the analog and/or digital domains.

FIG. 17B shows a block diagram of an implementation R210 of array 8200. Array R210 includes an implementation AP20 of audio preprocessing stage AP10 that includes analog preprocessing stages P10a and P10b. In one example, stages P10a and P10b are each configured to perform a highpass filtering operation (e.g., with a cutoff frequency of 50, 100, or 200 Hz) on the corresponding microphone signal.

It may be desirable for array R100 to produce the multichannel signal as a digital signal, that is to say, as a sequence of samples. Array 8210, for example, includes analog-to-digital converters (ADCs) C10a and C10b that are each arranged to sample the corresponding analog channel. Typical sampling rates for acoustic applications include 8 kHz, 12 kHz, 16 kHz, and other frequencies in the range of from about 8 to about 16 kHz, although sampling rates as high as about 44 kHz may also be used. In this particular example, array R210 also includes digital preprocessing stages P20a and P20b that are each configured to perform one or more preprocessing operations (e.g., echo cancellation, noise reduction, and/or spectral shaping) on the corresponding digitized channel to produce the corresponding channels MCS-1, MCS-2 of multichannel signal MCS. Although FIGS. 17A and 17B show two-channel implementations, it will be understood that the same principles may be extended to an arbitrary number of microphones and corresponding channels of multichannel signal MCS.

The methods and apparatus disclosed herein may be applied generally in any transceiving and/or audio sensing application, especially mobile or otherwise portable instances of such applications. For example, the range of configurations disclosed herein includes communications devices that reside in a wireless telephony communication system configured to employ a code-division multiple-access (CDMA) over-the-air interface. Nevertheless, it would be understood by those skilled in the art that a method and apparatus having features as described herein may reside in any of the various communication systems employing a wide range of technologies known to those of skill in the art, such as systems employing Voice over IP (VoIP) over wired and/or wireless (e.g., CDMA, TDMA, FDMA, and/or TD-SCDMA) transmission channels.

It is expressly contemplated and hereby disclosed that communications devices disclosed herein may be adapted for use in networks that are packet-switched (for example, wired and/or wireless networks arranged to carry audio transmissions according to protocols such as VoIP) and/or circuit-switched. It is also expressly contemplated and hereby disclosed that communications devices disclosed herein may be adapted for use in narrowband coding systems (e.g., systems that encode an audio frequency range of about four or five kilohertz) and/or for use in wideband coding systems (e.g., systems that encode audio frequencies greater than five kilohertz), including whole-band wideband coding systems and split-band wideband coding systems.

The foregoing presentation of the described configurations is provided to enable any person skilled in the art to make or use the methods and other structures disclosed herein. The flowcharts, block diagrams, and other structures shown and described herein are examples only, and other variants of these structures are also within the scope of the disclosure. Various modifications to these configurations are possible, and the generic principles presented herein may be applied to other configurations as well. Thus, the present disclosure is not intended to be limited to the configurations shown above but rather is to be accorded the widest scope consistent with the principles and novel features disclosed in any fashion herein, including in the attached claims as filed, which form a part of the original disclosure.

Those of skill in the art will understand that information and signals may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

Important design requirements for implementation of a configuration as disclosed herein may include minimizing processing delay and/or computational complexity (typically measured in millions of instructions per second or MIPS), especially for computation-intensive applications, such as applications for voice communications at sampling rates higher than eight kilohertz (e.g., 12, 16, or 44 kHz).

The various elements of an implementation of an apparatus as disclosed herein (e.g., apparatus A100, A104, A106, A108, MF100, A200) may be embodied in any combination of hardware, software, and/or firmware that is deemed suitable for the intended application. For example, such elements may be fabricated as electronic and/or optical devices residing, for example, on the same chip or among two or more chips in a chipset. One example of such a device is a fixed or programmable array of logic elements, such as transistors or logic gates, and any of these elements may be implemented as one or more such arrays. Any two or more, or even all, of these elements may be implemented within the same array or arrays. Such an array or arrays may be implemented within one or more chips (for example, within a chipset including two or more chips).

One or more elements of the various implementations of the apparatus disclosed herein (e.g., apparatus A100, A104, A106, A108, MF100, A200) may also be implemented in whole or in part as one or more sets of instructions arranged to execute on one or more fixed or programmable arrays of logic elements, such as microprocessors, embedded processors, IP cores, digital signal processors, FPGAs (field-programmable gate arrays), ASSPs (application-specific standard products), and ASICs (application-specific integrated circuits). Any of the various elements of an implementation of an apparatus as disclosed herein may also be embodied as one or more computers (e.g., machines including one or more arrays programmed to execute one or more sets or sequences of instructions, also called “processors”), and any two or more, or even all, of these elements may be implemented within the same such computer or computers.

A processor or other means for processing as disclosed herein may be fabricated as one or more electronic and/or optical devices residing, for example, on the same chip or among two or more chips in a chipset. One example of such a device is a fixed or programmable array of logic elements, such as transistors or logic gates, and any of these elements may be implemented as one or more such arrays. Such an array or arrays may be implemented within one or more chips (for example, within a chipset including two or more chips). Examples of such arrays include fixed or programmable arrays of logic elements, such as microprocessors, embedded processors, IP cores, digital signal processors, FPGAs, ASSPs, and ASICs. A processor or other means for processing as disclosed herein may also be embodied as one or more computers (e.g., machines including one or more arrays programmed to execute one or more sets or sequences of instructions) or other processors. It is possible for a processor as described herein to be used to perform tasks or execute other sets of instructions that are not directly related to a coherency detection procedure, such as a task relating to another operation of a device or system in which the processor is embedded (e.g., an audio sensing device). It is also possible for part of a method as disclosed herein to be performed by a processor of the audio sensing device and for another part of the method to be performed under the control of one or more other processors.

Those of skill will appreciate that the various illustrative modules, logical blocks, circuits, and tests and other operations described in connection with the configurations disclosed herein may be implemented as electronic hardware, computer software, or combinations of both. Such modules, logical blocks, circuits, and operations may be implemented or performed with a general purpose processor, a digital signal processor, an ASIC or ASSP, an FPGA or other programmable logic device, discrete gate or transistor logic, discrete hardware components, or any combination thereof designed to produce the configuration as disclosed herein. For example, such a configuration may be implemented at least in part as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a general purpose processor or other digital signal processing unit. A general purpose processor may be a microprocessor, but in the alternative, the processor may be any conventional processor, controller, microcontroller, or state machine. A processor may also be implemented as a combination of computing devices, e.g., a combination of a digital signal processor and a microprocessor, a plurality of microprocessors, one or more microprocessors in conjunction with a digital signal processor core, or any other such configuration. A software module may reside in RAM (random-access memory), ROM (read-only memory), nonvolatile RAM (NVRAM) such as flash RAM, erasable programmable ROM (EPROM), electrically erasable programmable ROM (EEPROM), registers, hard disk, a removable disk, a CD-ROM, or any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

It is noted that the various methods disclosed herein (e.g., method M100, M102) may be performed by an array of logic elements such as a processor, and that the various elements of an apparatus as described herein may be implemented as modules designed to execute on such an array. As used herein, the term “module” or “sub-module” can refer to any method, apparatus, device, unit or computer-readable data storage medium that includes computer instructions (e.g., logical expressions) in software, hardware or firmware form. It is to be understood that multiple modules or systems can be combined into one module or system and one module or system can be separated into multiple modules or systems to perform the same functions. When implemented in software or other computer-executable instructions, the elements of a process are essentially the code segments to perform the related tasks, such as with routines, programs, objects, components, data structures, and the like. The term “software” should be understood to include source code, assembly language code, machine code, binary code, firmware, macrocode, microcode, any one or more sets or sequences of instructions executable by an array of logic elements, and any combination of such examples. The program or code segments can be stored in a processor readable medium or transmitted by a computer data signal embodied in a carrier wave over a transmission medium or communication link.

The implementations of methods, schemes, and techniques disclosed herein may also be tangibly embodied (for example, in one or more computer-readable media as listed herein) as one or more sets of instructions readable and/or executable by a machine including an array of logic elements (e.g., a processor, microprocessor, microcontroller, or other finite state machine). The term “computer-readable medium” may include any medium that can store or transfer information, including volatile, nonvolatile, removable and non-removable media. Examples of a computer-readable medium include an electronic circuit, a computer-readable storage medium (e.g., a ROM, erasable ROM (EROM), flash memory, or other semiconductor memory device; a floppy diskette, hard disk, or other magnetic storage; a CD-ROM/DVD or other optical storage), a transmission medium (e.g., a fiber optic medium, a radio-frequency (RF) link), or any other medium which can be accessed to obtain the desired information. The computer data signal may include any signal that can propagate over a transmission medium such as electronic network channels, optical fibers, air, electromagnetic, RF links, etc. The code segments may be downloaded via computer networks such as the Internet or an intranet. In any case, the scope of the present disclosure should not be construed as limited by such embodiments.

Each of the tasks of the methods described herein may be embodied directly in hardware, in a software module executed by a processor, or in a combination of the two. In a typical application of an implementation of a method as disclosed herein, an array of logic elements (e.g., logic gates) is configured to perform one, more than one, or even all of the various tasks of the method. One or more (possibly all) of the tasks may also be implemented as code (e.g., one or more sets of instructions), embodied in a computer program product (e.g., one or more data storage media such as disks, flash or other nonvolatile memory cards, semiconductor memory chips, etc.), that is readable and/or executable by a machine (e.g., a computer) including an array of logic elements (e.g., a processor, microprocessor, microcontroller, or other finite state machine). The tasks of an implementation of a method as disclosed herein may also be performed by more than one such array or machine. In these or other implementations, the tasks may be performed within a device for wireless communications such as a cellular telephone or other device having such communications capability. Such a device may be configured to communicate with circuit-switched and/or packet-switched networks (e.g., using one or more protocols such as VoIP). For example, such a device may include RF circuitry configured to receive and/or transmit encoded frames.

It is expressly disclosed that the various methods disclosed herein may be performed by a portable communications device such as a handset, headset, or portable digital assistant (PDA), and that the various apparatus described herein may be included within such a device. A typical real-time (e.g., online) application is a telephone conversation conducted using such a mobile device.

In one or more exemplary embodiments, the operations described herein may be implemented in hardware, software, firmware, or any combination thereof. If implemented in software, such operations may be stored on or transmitted over a computer-readable medium as one or more instructions or code. A computer-readable medium may be any medium that can be accessed by a computer. The term “computer-readable media” includes both computer-readable storage media and communication (e.g., transmission) media. By way of example, and not limitation, computer-readable storage media can comprise an array of storage elements, such as semiconductor memory (which may include without limitation dynamic or static RAM, ROM, EEPROM, and/or flash RAM), or ferroelectric, magnetoresistive, ovonic, polymeric, or phase-change memory; CD-ROM or other optical disk storage; and/or magnetic disk storage or other magnetic storage devices. Such storage media may store information in the form of instructions or data structures that can be accessed by a computer. Communication media can comprise any medium that can be used to carry desired program code in the form of instructions or data structures and that can be accessed by a computer, including any medium that facilitates transfer of a computer program from one place to another. Also, any connection is properly termed a computer-readable medium. For example, if the software is transmitted from a website, server, or other remote source using a coaxial cable, fiber optic cable, twisted pair, digital subscriber line (DSL), or wireless technology such as infrared, radio, and/or microwave, then the coaxial cable, fiber optic cable, twisted pair, DSL, or wireless technology such as infrared, radio, and/or microwave are included in the definition of medium. Disk and disc, as used herein, includes compact disc (CD), laser disc, optical disc, digital versatile disc (DVD), floppy disk and Blu-ray Disc™ (Blu-Ray Disc Association, Universal City, Calif.), where disks usually reproduce data magnetically, while discs reproduce data optically with lasers. Combinations of the above should also be included within the scope of computer-readable media.

An acoustic signal processing apparatus as described herein may be incorporated into an electronic device that accepts speech input in order to control certain operations, or may otherwise benefit from separation of desired noises from background noises, such as communications devices. Many applications may benefit from enhancing or separating clear desired sound from background sounds originating from multiple directions. Such applications may include human-machine interfaces in electronic or computing devices which incorporate capabilities such as voice recognition and detection, speech enhancement and separation, voice-activated control, and the like. It may be desirable to implement such an acoustic signal processing apparatus to be suitable in devices that only provide limited processing capabilities.

The elements of the various implementations of the modules, elements, and devices described herein may be fabricated as electronic and/or optical devices residing, for example, on the same chip or among two or more chips in a chipset. One example of such a device is a fixed or programmable array of logic elements, such as transistors or gates. One or more elements of the various implementations of the apparatus described herein may also be implemented in whole or in part as one or more sets of instructions arranged to execute on one or more fixed or programmable arrays of logic elements such as microprocessors, embedded processors, IP cores, digital signal processors, FPGAs, ASSPs, and ASICs.

It is possible for one or more elements of an implementation of an apparatus as described herein to be used to perform tasks or execute other sets of instructions that are not directly related to an operation of the apparatus, such as a task relating to another operation of a device or system in which the apparatus is embedded. It is also possible for one or more elements of an implementation of such an apparatus to have structure in common (e.g., a processor used to execute portions of code corresponding to different elements at different times, a set of instructions executed to perform tasks corresponding to different elements at different times, or an arrangement of electronic and/or optical devices performing operations for different elements at different times).

What is claimed is:

1. A method of processing a multichannel signal that includes a directional component, said method comprising:
performing a first directionally selective processing operation on a first signal to produce a residual signal;
performing a second directionally selective processing operation on a second signal to produce an enhanced signal;
based on information from the produced residual signal, calculating a plurality of filter coefficients of an inverse filter; and
performing a dereverberation operation on the enhanced signal to produce a dereverberated signal,
wherein the dereverberation operation is based on the calculated plurality of filter coefficients, and
wherein the first signal includes at least two channels of the multichannel signal, and the second signal includes at least two channels of the multichannel signal, and
wherein said performing the first directionally selective processing operation on the first signal includes reducing energy of the directional component within the first signal relative to a total energy of the first signal, and
wherein said performing the second directionally selective processing operation on the second signal includes increasing energy of the directional component within the second signal relative to a total energy of the second signal.

2. The method according to claim 1, wherein said first directionally selective processing operation is a blind source separation operation.

3. The method according to claim 1, wherein said first directionally selective processing operation is a null beamforming operation.

4. The method according to claim 1, wherein said first directionally selective processing operation comprises:
for each of a plurality of different frequency components of the first signal, calculating a difference between a phase of the frequency component in a first channel of the first signal and a phase of the frequency component in a second channel of the first signal, and
based on said calculated phase differences in the first signal, attenuating a level of at least one among the plurality of different frequency components of the first signal relative to a level of another among the plurality of different frequency components of the first signal.

5. The method according to claim 1, wherein said first directionally selective processing operation is a decorrelation operation configured to reduce the energy of the directional component within the first signal relative to the total energy of the first signal.

6. The method according to claim 1, wherein said second directionally selective processing operation is a blind source separation operation.

7. The method according to claim 1, wherein said second directionally selective processing operation is a beamforming operation.

8. The method according to claim 1, wherein said second directionally selective processing operation comprises:
for each of a plurality of different frequency components of the second signal, calculating a difference between a phase of the frequency component in a first channel of the second signal and a phase of the frequency component in a second channel of the second signal, and
based on said calculated phase differences in the second signal, increasing a level of at least one among the plurality of different frequency components of the second signal relative to a level of another among the plurality of different frequency components of the second signal.

9. The method according to claim 1, wherein said method comprises performing a blind source separation operation on the multichannel signal, and
wherein said blind source separation operation includes the first and second directionally selective processing operations, and
wherein the first signal is the multichannel signal and the second signal is the multichannel signal.

10. The method according to claim 1, wherein said calculating the plurality of filter coefficients comprises fitting an autoregressive model to the produced residual signal.

11. The method according to claim 1, wherein said calculating a plurality of filter coefficients comprises calculating the plurality of filter coefficients as parameters of an autoregressive model that is based on the produced residual signal.

12. The method according to claim 1, wherein an average gain response of the dereverberation operation between two kilohertz and three kilohertz is at least three decibels greater than an average gain response of the dereverberation operation between three hundred and four hundred Hertz.

13. The method according to claim 1, wherein, for at least one among the first and second directionally selective processing operations, an absolute difference between a minimum gain response of the operation and a maximum gain response of the operation, with respect to direction, over a frequency range of from two thousand to three thousand Hertz is greater than an absolute difference between a minimum gain response of the operation and a maximum gain response of the operation, with respect to direction, over a frequency range of from three hundred to four hundred Hertz.

14. A computer-readable storage medium comprising tangible features that when read by a processor cause the processor to perform a method of processing a multichannel signal that includes a directional component, said method comprising:
performing a first directionally selective processing operation on a first signal to produce a residual signal;
performing a second directionally selective processing operation on a second signal to produce an enhanced signal;
based on information from the produced residual signal, calculating a plurality of filter coefficients of an inverse filter; and
performing a dereverberation operation on the enhanced signal to produce a dereverberated signal,
wherein the dereverberation operation is based on the calculated plurality of filter coefficients, and
wherein the first signal includes at least two channels of the multichannel signal, and the second signal includes at least two channels of the multichannel signal, and
wherein said performing the first directionally selective processing operation on the first signal includes reducing energy of the directional component within the first signal relative to a total energy of the first signal, and
wherein said performing the second directionally selective processing operation on the second signal includes increasing energy of the directional component within the second signal relative to a total energy of the second signal.

15. An apparatus for processing a multichannel signal that includes a directional component, said apparatus comprising:
a first filter configured to perform a first directionally selective processing operation on a first signal to produce a residual signal;
a second filter configured to perform a second directionally selective processing operation on a second signal to produce an enhanced signal;
a calculator configured to calculate a plurality of filter coefficients of an inverse filter, based on information from the produced residual signal; and
a third filter, based on the calculated plurality of filter coefficients, that is configured to filter the enhanced signal to produce a dereverberated signal,
wherein the first signal includes at least two channels of the multichannel signal, and the second signal includes at least two channels of the multichannel signal, and
wherein said first directionally selective processing operation includes reducing energy of the directional component within the first signal relative to a total energy of the first signal, and
wherein said second directionally selective processing operation includes increasing energy of the directional component within the second signal relative to a total energy of the second signal.

16. The apparatus according to claim 15, wherein said first directionally selective processing operation is a blind source separation operation.

17. The apparatus according to claim 15, wherein said first directionally selective processing operation is a null beamforming operation.

18. The apparatus according to claim 15, wherein said first directionally selective processing operation comprises:
for each of a plurality of different frequency components of the first signal, calculating a difference between a phase of the frequency component in a first channel of the first signal and a phase of the frequency component in a second channel of the first signal, and
based on said calculated phase differences in the first signal, attenuating a level of at least one among the plurality of different frequency components of the first signal relative to a level of another among the plurality of different frequency components of the first signal.

19. The apparatus according to claim 15, wherein said first directionally selective processing operation is a decorrelation operation configured to reduce the energy of the directional component within the first signal relative to the total energy of the first signal.

20. The apparatus according to claim 15, wherein said second directionally selective processing operation is a blind source separation operation.

21. The apparatus according to claim 15, wherein said second directionally selective processing operation is a beamforming operation.

22. The apparatus according to claim 15, wherein said second directionally selective processing operation comprises:
for each of a plurality of different frequency components of the second signal, calculating a difference between a phase of the frequency component in a first channel of the second signal and a phase of the frequency component in a second channel of the second signal, and
based on said calculated phase differences in the second signal, increasing a level of at least one among the plurality of different frequency components of the second signal relative to a level of another among the plurality of different frequency components of the second signal.

23. The apparatus according to claim 15, wherein said apparatus comprises a decorrelator configured to perform a blind source separation operation on the multichannel signal, and
wherein said decorrelator includes said first filter and said second filter, and
wherein the first signal is the multichannel signal and the second signal is the multichannel signal.

24. The apparatus according to claim 15, wherein said calculator is configured to fit an autoregressive model to the produced residual signal.

25. The apparatus according to claim 15, wherein said calculator is configured to calculate the plurality of filter coefficients as parameters of an autoregressive model that is based on the produced residual signal.

26. The apparatus according to claim 15, wherein an average gain response of the third filter between two kilohertz and three kilohertz is at least three decibels greater than an average gain response of the third filter between three hundred and four hundred Hertz.

27. The method according to claim 15, wherein, for at least one among the first and second directionally selective processing operations, an absolute difference between a minimum gain response of the operation and a maximum gain response of the operation, with respect to direction, over a frequency range of from two thousand to three thousand Hertz is greater than an absolute difference between a minimum gain response of the operation and a maximum gain response of the operation, with respect to direction, over a frequency range of from three hundred to four hundred Hertz.

28. An apparatus for processing a multichannel signal that includes a directional component, said apparatus comprising:
means for performing a first directionally selective processing operation on a first signal to produce a residual signal;
means for performing a second directionally selective processing operation on a second signal to produce an enhanced signal;
means for calculating a plurality of filter coefficients of an inverse filter, based on information from the produced residual signal; and
means for performing a dereverberation operation on the enhanced signal to produce a dereverberated signal,
wherein the dereverberation operation is based on the calculated plurality of filter coefficients, and
wherein the first signal includes at least two channels of the multichannel signal, and the second signal includes at least two channels of the multichannel signal, and
wherein said means for performing the first directionally selective processing operation on the first signal is configured to reduce energy of the directional component within the first signal relative to a total energy of the first signal, and
wherein said means for performing the second directionally selective processing operation on the second signal is configured to increase energy of the directional component within the second signal relative to a total energy of the second signal.

29. The apparatus according to claim 28, wherein said first directionally selective processing operation is a blind source separation operation.

30. The apparatus according to claim 28, wherein said first directionally selective processing operation is a null beamforming operation.

31. The apparatus according to claim 28, wherein said first directionally selective processing operation comprises:
for each of a plurality of different frequency components of the first signal, calculating a difference between a phase of the frequency component in a first channel of the first signal and a phase of the frequency component in a second channel of the first signal, and
based on said calculated phase differences in the first signal, attenuating a level of at least one among the plurality of different frequency components of the first signal relative to a level of another among the plurality of different frequency components of the first signal.

32. The apparatus according to claim 28, wherein said first directionally selective processing operation is a decorrelation operation configured to reduce the energy of the directional component within the first signal relative to the total energy of the first signal.

33. The apparatus according to claim 28, wherein said second directionally selective processing operation is a blind source separation operation.

34. The apparatus according to claim 28, wherein said second directionally selective processing operation is a beamforming operation.

35. The apparatus according to claim 28, wherein said second directionally selective processing operation comprises:
for each of a plurality of different frequency components of the second signal, calculating a difference between a phase of the frequency component in a first channel of the second signal and a phase of the frequency component in a second channel of the second signal, and
based on said calculated phase differences in the second signal, increasing a level of at least one among the plurality of different frequency components of the second signal relative to a level of another among the plurality of different frequency components of the second signal.

36. The apparatus according to claim 28, wherein said apparatus comprises means for performing a blind source separation operation on the multichannel signal, and
wherein said means for performing a blind source separation operation includes said means for performing the first directionally selective processing operation and said means for performing the second directionally selective processing operation, and
wherein the first signal is the multichannel signal and the second signal is the multichannel signal.

37. The apparatus according to claim 28, wherein said means for calculating the plurality of filter coefficients is configured to fit an autoregressive model to the produced residual signal.

38. The apparatus according to claim 28, wherein said means for calculating a plurality of filter coefficients is configured to calculate the plurality of filter coefficients as parameters of an autoregressive model that is based on the produced residual signal.

39. The apparatus according to claim 28, wherein an average gain response of the dereverberation operation between two kilohertz and three kilohertz is at least three decibels greater than an average gain response of the dereverberation operation between three hundred and four hundred Hertz.

40. The apparatus according to claim 28, wherein, for at least one among the first and second directionally selective processing operations, an absolute difference between a minimum gain response of the operation and a maximum gain response of the operation, with respect to direction, over a frequency range of from two thousand to three thousand Hertz is greater than an absolute difference between a minimum gain response of the operation and a maximum gain response of the operation, with respect to direction, over a frequency range of from three hundred to four hundred Hertz.
